(19) United States
(12) Patent Application Publication
(10) Pub. No.: US 2007/0024706 A1
(43) Pub. Date: Feb. 1, 2007

(54) Systems and methods for providing high-resolution regions-of-interest

(76) Inventors: Robert H. Brannon JR., Dripping Springs, TX (US); Eric Friedrichs, Georgetown, TX (US); Roger K. Richter, Leander, TX (US); Dane A. Thyssen, Austin, TX (US); Jason C. Weaver, Austin, TX (US)

Correspondence Address: O'KEEFE, EGAN & PETERMAN, L.LP., Building C, Suite 200, 1101 Capital of Texas Highway South, Austin, TX, 78746, US

(21) Appl. No.: 11/442,658

(22) Filed: May 26, 2006

Related U.S. Application Data
(63) Continuation-in-part of application No. 11/194,914, filed on Aug. 1, 2005.
(60) Provisional application No. 60/710,316, filed on Aug. 22, 2005.

(51) Int. Cl. H04N 7/18; H04N 9/47

(52) U.S. Cl. 348/142; 348/143

(57) ABSTRACT

Systems and methods for providing high-quality region of interest (HQ-ROI) viewing within an overall scene by enabling one or more HQ-ROIs to be viewed in a controllable fashion, as higher quality ‘windows-within-a-window’ of regions (spatial subsets) of a scene.

This patent application is a continuation-in-part of U.S. patent application Ser. No. 11/194,914, titled “Systems and Methods for Video Stream Selection,” by Roger K. Richter, et al., filed on Aug. 1, 2005, and which is incorporated herein by reference in its entirety. This patent application also claims priority from copending U.S. Provisional Patent Application Ser. No. 60/710,316, filed Aug. 22, 2005, and entitled “Systems and Methods for Providing Dynamic High-Resolution Regions-Of-Interest (ROIS) via Video Stream Management from a Multi-Stream Video Source” by Robert H. Brannon, Jr., et al., the entire disclosure of which is incorporated herein by reference.

### FIELD OF THE INVENTION

This invention relates generally to video streams, and more particularly to creation and/or display of video streams.

### BACKGROUND OF THE INVENTION

Presently, in the monitoring and surveillance markets it is becoming common practice to deploy IP-based monitoring and surveillance systems. These systems include IP-based video sources which usually consist of some combination of Web or Streaming IP cameras, and/or IP-based video encoding devices that are coupled to analog cameras for providing video via a web interface or as streaming media. All of these prior devices provide video, and sometimes audio, across a network medium for viewing by PC-based software applications (“client apps”) that receive, decode and display the selected video streams. The video sources, along with the viewing applications, and potentially one or more recording systems, comprise an overall monitoring or surveillance system.

Currently, video streaming technology within the internet video, monitoring, and surveillance industries is primarily based on the design point of delivering fixed resolution and rate video streams for consumption by client software. In practice, this is usually accomplished using a video source, usually a camera, a video access device, usually a video stream server (the camera and stream server components could be one device), and client viewing software that operates on a Personal Computer (PC) with an intervening network used to transfer the video stream(s) and the associated control connections. Also, in practice, the source device and stream server, provide one stream of a fixed resolution, for example 640H×480V, at a predetermined frame and/or bit rate (e.g. 30 frames/second, 768 Kbps, etc.). This poses a significant set of problems for viewing client software due to the fact that fixed resolution/rate video sources, whether live or stored, do not match well in most cases to bandwidth availability of the intervening transit network, and in some cases, local computer resource limitations (processing power, memory availability, etc.).

In the case where the video sources are higher resolution (greater than or equal to VGA quality), the ability or likelihood to satisfactorily view such video streams is relatively low due to the fact that the bandwidth involved is in the 2.5 Mbps throughput range or greater. To state the problem in a succinct manner, a live or prerecorded video stream from a 1 Megapixel video source at 30 fps (full motion) is, minimally, in the 6 Mbps to 8+Mbps range using a video compression protocol like MPEG-4. Furthermore, many video sources today use Motion JPEG which provides less video compression, thus increasing the overall bandwidth requirement for the same stream into the 20+Mbps throughput range. These attributes pose a significant problem from both a bandwidth and compute perspective. Since the video source is fixed, the frame rate and/or resolution cannot be modified, the viewer is incapable of adapting the video source to its environmental constraints. This problem is exacerbated in environments where the viewer either needs or desires to view multiple video sources simultaneously which is a common practice in the monitoring and surveillance industries.

As an example, assume a Windows-based PC viewing client desires to simultaneously watch six camera sources across a network. Each camera source has a traditional resolution of 640H×480V and produces a video stream at a frame rate of 30 frames/second (fps). Currently, this video stream would have a bitrate ranging from 2 Mbps to 20 Mbps due to the various video compression types. Assume for this example that a stream rate of 3 Mbps is chosen. For a PC to watch six camera sources via 3 Mbps streams consisting of 640H×480V 30 fps video is roughly the equivalent of trying to play six conventional digital video disks (DVDs) simultaneously. Therefore, there is a significant compute burden, and Input/Output (I/O) processing burden, associated with each stream.

To enable the viewing client to simultaneously watch the six camera sources using conventional video streaming technology, it is possible to reduce the resolution (horizontal & vertical dimensions) of the video images, reduce the frame rate of the video stream, and/or to increase the compression factor used to compress the video stream into a lower bitrate. However, all of the prior options diminish the observed video quality. Furthermore, increasing the compression factor does not diminish the compute burden associated with a video stream (i.e., it might alleviate network bandwidth issues but the compute issues are still present).

Compute problems are further exacerbated by the fact that the viewing space available on a typical conventional viewing client screen (monitor, LCD, etc.) does not change with respect to the characteristics of the incoming video stream, but with respect to the viewing operations being performed by the user. In short, the more cameras/scenes simultaneously viewed by a client, the smaller the dimensions of the viewing ‘window’ for that scene. For example, assuming that there is a 1024H×768V viewing space at the client, six equally-sized simultaneous views would each occupy an individual window space of 170H×128V viewing. Similarly, four equally-sized views would each occupy a 256H×192V window, and eight equally-sized views would each occupy a 128H×96V window each. However, the resolution of such viewing windows on the client application do not match the native, or incoming, resolutions from each common camera/video source. This resolution mismatch between source and viewing client requires client applications to scale incoming video streams into the desired viewing window, many times at undesirable scaling factors, which consumes more compute and memory bandwidth, and produces video quality issues that are the resultant side-effects from scaling.

Problems become more complex when the camera/video source is factored into this scenario. To provide better bandwidth and compute management, many users configure their conventional cameras/video sources to generate video in one of two basic categories: A) better resolution at lower frame rates (e.g. 640H×480V @ 5 fps), or B) lower resolutions at higher frame rates (e.g., 320H×240V @ 15 fps). These categories represent the trade-offs forced upon the user trying to obtain ‘useable’ video from multiple simultaneous sources that have fixed video stream characteristics.

Due to the above-described issues regarding bandwidth loading, compute resource limitations, video quality requirements (frame rate and resolution), and optimal video presentation, most of the work to process and present video takes place in a viewing application. In regards to the aforementioned constraints and issues, users are typically presented with the choice of receiving a high resolution video stream at a reduced frame rate (1-10 Fps) or receiving a lower resolution video stream (e.g., SIF, 320H×240V) at a full-motion frame rate (i.e. 25 fps/30 fps). The reasons for these trade-offs are best explained by example. A high resolution image obviously has more information (detail) than a lower resolution image of the same object(s). However, there is a bandwidth and compute resource cost for each pixel in an image. As previously mentioned, a 640H×480V image stream can range from 2 Mbps to 20+Mbps depending upon the compression protocol employed. Additionally, the more pixels there are, the more compute and memory are consumed at the viewing application. This is why higher resolution images are usually viewed/streamed at lower frames rates; to allow for the large amount of local compute and memory required to process 1M/pixel, or greater, images. However, this approach does not solve the many scenarios where full frame rates are required such that motion-related activity is not compromised within the video.

Additionally, most PC environments have displays that have display attributes such as resolution and aspect ratio, that are, in many cases, different than that of the video sources. Also, most Windows, Apple and Linux applications allow users (viewers) to dynamically resize their application windows, or use default application settings, such that video quality may be adversely affected by scaling effects required to match video stream attributes (resolution and aspect ratio) to the viewing space on a display monitor.

Current industry practice is that each of the video sources produces a single format, single resolution stream for viewing and, potentially, for recording purposes. However, problems arise as users demand better video quality. Primarily, video quality is increased by providing higher resolution video images. Resolution equals the number of pixels representing an image. The more pixels, the more detailed information contained in that video image, or ‘frame’. Pixels are represented digitally by binary data. Therefore, more pixels equal more information. Since a video image is 2-dimensional (2D; it has horizontal and vertical dimensions), increases in each of these axes produces a much larger amount of information in a multiplicative manner. For example, using the common YUV 4:2:0 format, with 8-bits of information per pixel (YUV 4:2:0-8b), a 320H×240V Standard Interchange Format (SIF) resolution video frame is 115,200 bytes in size. A 640H×480V video frame, of the same format, is 460,800 bytes is size which is 4× larger. Additionally, an 800H×600V YUV 4:2:0-8 b video frame is 720,000 bytes in size.

Each of the prior examples is for a single video frame. A video stream consists of series of frames at a rate usually defined in ‘frames per second’ (fps). This also adds to the cumulative impact of increases in image resolution. The use of video compression protocols greatly helps in the reduction of the amount of data transferred in a video stream, but the affect of increased image resolution is still very significant. For example, a 320H×240V video stream, at 30 fps, with a compression ratio of 20× generates approximately 1.382 Mb/sec of data. A 640H×480V stream at the same frame rate and compression ratio generates a 5.5296 Mb/sec data stream. As is obvious, increases in image resolution cause serious impacts to the bandwidth consumed to convey those images.

In addition to bandwidth, the amount of compute and memory resources required to process a video stream are also proportional to the amount of data sent and received. For example, a video compression protocol that requires 120 central processing unit (CPU) cycles/pixel to encode on a specific type of CPU, would require 13,824,000 cycles per SIF video frame to encode. At 30 fps, the required compute load would be at least 414,720,000 cycles/second just to process the video, not including other operations such as networking, memory management, task switching, and the execution of other tasks (applications). The video processing requirement alone would consume roughly a dedicated 415 MHz reduced instruction set computer (RISC)CPU, or greater, to accomplish. A 640H×480V (4 SIF) 30 fps video stream would roughly require a dedicated 1.66 GHz RISC CPU, or greater, to process (encode) the video stream alone, not counting other system overhead.

The foregoing shows that for processing and transport of higher resolution video, there is an extralinear increase in cost and complexity factors that grow as the resolution of a set of video images increases. Therefore, achieving higher video quality via increases in resolution becomes problematic especially with respect to cost. The industry currently deals with these factors using the following alternatives:
A) reducing the overall frame rates per second, in order to maintain spatial fidelity, and/or . . .
B) increasing the compression factor for a given video stream hoping that the quality loss does not impair recognition beyond applicability, and/or . . .
C) sending only a portion of a high resolution video image in a ‘snapshot’, or . . .
D) reducing the resolution of the overall image in order to keep a frame rate that captures higher-motion events better.

Each one of the aforementioned alternatives has its own set of drawbacks. Alternative A) reduces compute and bandwidth consumption but affects temporal fidelity (i.e., motion related video quality is diminished). Alternatives B) through D) reduce spatial fidelity (i.e., some resolution and/or video quality is lost). The net result is that a user cannot feasibly get the spatial quality (i.e., resolution with quality) and temporal quality (i.e., fps rates) simultaneously.

Another side-effect of viewing and monitoring video with a high-resolution (“hi-res”) video source is the impact of the amount of data generated by high-resolution images. A 1280H×1024V image, in YUV 4:2:0-8b format is 1,966,080 bytes in size and this amount of information is not all useful or viable information. In other words, out of a 1.966 MB hi-res image, for example, only a portion of the image is usually important or necessary. For perspective, consider a scene where a high-resolution (“hi-res”) camera monitors a lobby or parking garage entry/exit. In either of these scenarios, the higher resolution attributes of the video images provides much greater detail, yet in most cases, only a portion of the overall scene is needed. In this case, it may be that a 480H×360V section (259,200 bytes YUV 4:2:0-8b), centered on the lobby's doorways, or on the parking garage's entry/exit area, is the only significant or interesting zone within the overall scene. This means that slightly more than ⅛^{th} of each video frame, which affects bandwidth, compute resources (CPU load, memory consumption), and potentially storage allocation, is valuable. This presents a gross over-commitment of resources for data that is not significant or particularly meaningful. However, there are many scenarios where the significant region-of-interest (ROI) is not spatially static (i.e., it may need to be moved around or repositioned based on dynamic conditions).

Consider an example situation in which a “video source” in the form of a multi-stream camera device is connected to a network, and in which a Personal Computer (PC) with a client viewing application (software) is also connected to the network. Assume the video source is configured to provide video streams using a common video protocol (e.g., such as MPEG-2 or MPEG-4) and a protocol for advertising its video stream attributes (parameters). Since the video source is a high resolution device, in this example a 1280H×720V image format, with scaling and windowing (extraction) logic, it is capable of providing streams in various resolutions. For this example, assume that the video source may be configured to provide 1280H×720V, 640H×360V, and/or 320H×180V image resolutions for video streams.

The significance of the various aforementioned image resolutions of the above example is the fact that the full scene views, by virtue of their scaled-down resolutions, have relational zoom factors as by-products of their scaling. For example, the 640H×360V image has a −4× scale factor with respect to the native image from which it is derived (scaled). In other words, the 1280H×720V image must be down-scaled by ½ in each dimension (horizontal and vertical) to achieve the resultant 640H×360V image. This means that the 640H×360V image has a negative zoom factor of 4× (−2*2). This also means that for any given area of a scene, there are ¼^{th} the number of pixels representing that spatial area within the 640H×360V image than there are in the 1280H×720V image (due to scaling −2× in two dimensions). Conversely, any given area within a scene in the 1280H×720V image has a 4× zoom, or spatial quality increase (SQI), versus the same area of the scene present in a 640H×360V image.

To further illustrate, consider an object in a scene such as an automobile. For reference sake, the automobile fits within a 240H×120V pixel area in the native hi-res image (1280H×720V). In the 640H×360V image, the same object (automobile) would occupy a 120H×60V spatial area within the same scene; this space is ¼^{th} the overall resolution of the same object in the hi-res image (240*120=28,800 pixels versus 120*60=7200 pixels). The same concept holds true for the other resultant image resolution, 320H×180V. This image resolution is ¼^{th} the resolution of 640H×360V and 1/16^{th} the resolution of the 1280H×720V image. As such, any given object within the 320H×180V image has 16 times the spatial resolution when it is viewed in the original hi-res format.

In addition to the above-described effects of ‘down-scaling’ at the video source, which help provide various resolutions for bandwidth, compute resource, and potentially storage conservation, there is a an inverse scaling operation (scale-up) that may take effect at the viewing application. For instance, a viewing application has to balance compute load and/or the bandwidth associated with the resolution of a video stream with respect to the display dimensions of the viewing window corresponding with that stream. For example, assume a client viewing application is receiving a 320H×180V stream, at 640 Kbps, and is displaying that video information into a 320H×180V window. In this situation, everything is fine. However, assume the user of the application now increases the viewing window size to 480H×270V, for example. The viewing application is now forced to scale the incoming 320H×180V images into the 480H×270V viewing window. This produces a ‘scale-up’ factor of 2.25× (1.5H*1.5V). However, this is a dilution of the original spatial fidelity of the 320H×180V image. This is considered a dilution since the scale-up/zoom-out operation is increasing the overall image resolution by 2.25× but without sufficient information to do so and maintain the original quality/fidelity level. This is why ‘zooming-up’ a picture results in a larger view but at the expense of overall quality. This relationship is inversely proportional: the larger the scale-up factor, the lower the overall spatial fidelity of an image. In other words, scaling-down, in general, maintains overall quality with respect to resolution, but scaling-up dilutes, or lessens, video quality with respect to resolution.

Also involved in these operations are the display environment characteristics. Most PC/workstation display devices greatly exceed the video sources in resolution. Additionally, the aspect ratio of a display screen and the pixels themselves may vary from the video source. Additionally, all popular Operating System (O/S) environments enable applications to operate graphically in display windows that are arbitrarily sizeable by a user (i.e., a user may dynamically resize an application window to any arbitrary size within certain environmental constraints). These issues almost guarantee that an incoming video stream will be scaled, to some degree, to match the viewing characteristics of the display space for that stream. Therefore, in these circumstances, there will be some set of scaling artifacts. The prior discussion illustrates some of the dilemmas that surround the streaming and viewing of video, especially when matching video streams to display characteristics.

In the past, a separate co-processor has been employed to enable viewing of a single high bandwidth high resolution stream, however, this implementation requires additional client processing hardware expense.

### SUMMARY OF THE INVENTION

Disclosed in one embodiment herein are systems and methods that may be implemented to provide high-quality regions of interest (HQ-ROIs) viewing within an overall scene by enabling one or more HQ-ROIs to be viewed in a controllable fashion, as relatively higher quality ‘windows-within-a-window’ regions (spatial subsets) of a scene. A HQ-ROI video stream may be comprised of any set of video stream attributes (e.g., higher resolution, less video compression, enhanced color format, greater pixel definition, etc.) that represent a HQ-ROI view of greater viewing quality with respect to the view of a corresponding base, or full scene, viewing stream. For example, a HQ-ROI region may have the same resolution as the same area within the full scene view but with less video compression and/or an enhanced color format and/or greater pixel definition to accomplish additional quality; i.e., not necessarily via the use of high resolution.

In one embodiment, the disclosed systems and methods may be implemented, for example, to provide real-time viewing capabilities such that one or more high-resolution ROIs may be provided in addition to, and with respect to, a full-scene view in a manner such that a scene viewed by a user (e.g., viewer) has a hi-res ‘window-in-a-window’ for dynamically, or statically, viewing the ROIs within the given scene. For example, a viewer may be provided with the ability to dynamically or statically use a spatially smaller high resolution (“hi-res”) window, representing a ROI, to view a spatial subset of the overall scene with much greater quality. This may be accomplished, for example, by utilizing a multi-stream video source that provides at least one standard full-scene video stream, and at least a second video stream that is enabled for higher resolution streaming with spatial coordinates that fit within the dimensions of first full scene video stream, and by utilizing a viewing application that understands the multi-stream capabilities of the video source such that it may manage the streams to accomplish controllable ROI viewing capabilities.

In the practice of the disclosed systems and methods, a multi-stream video source may be optionally configured with the ability to spatially move the reference coordinates of an ROI stream within the scene's overall image, e.g., via some set of suitable control commands such as those implemented for Pan-Tilt-Zoom (PTZ) cameras. The ability to perform the ROI control logic may be implemented, for example, at a viewing application, or some ancillary device such as a joystick, such that the HQ-ROI stream is viewed as a high-quality window within the overall relatively lower quality scene that is movable dynamically by the viewer. Additionally, the use of PTZ, or similar commands, may be employed to allow the viewer to change the scaling factor of the video images within an HQ-ROI stream such that the equivalent of a (digital) ‘Zoom’ feature is provided. In addition, the HQ-ROI video stream may be implemented to provide the ability to change the spatial dimensions associated with the video images such that the HQ-ROI may be re-sized (i.e., so that the overall window dimensions of the HQ-ROI view may be changed; e.g., from a 240H×120V view/stream to a 320H×180V view/stream). PTZ or similar commands may be transferred on the same packet network over which video streams are accessed, and/or on a network separate from the video transport packet network, e.g., over a serial network (RS-485/422) for surveillance industry applications.

In one embodiment disclosed herein, systems and methods are provided for selecting reception of video streams in an adaptive and, in one embodiment, dynamic fashion, for example, from a multi-stream video source. In one embodiment, reception of the video streams may be dynamically switched such that optimal bandwidth is selected in adaptive fashion using a set of video parameters, such as the size or dimensions of the viewing window, and environmental related parameters, such as bandwidth and processing resource usage, to ascertain the optimal stream selection. In another embodiment, a video stream of an image may be selected for viewing that is adapted to the needs of a user while at the same time maximizing efficiency of system resource usage, e.g., by adaptively selecting a video stream that meets the minimum resolution required by a user for a given viewing situation (and no more) to increase response time, reduce bandwidth requirements, and to reduce scaling artifacts.

The disclosed systems and methods may be beneficially implemented for surveillance applications or, for example, for other types of video viewing applications such as in situations where multiple video sources (e.g., video cameras) are viewed simultaneously or in situations where a user is allowed to dynamically resize a viewing window on a display device.

The disclosed systems and methods may be implemented in one embodiment to enable optimized simultaneous viewing of multiple video sources for each individual viewing client. This is in contrast to conventional video viewing systems in which the cumulative effect of viewing multiple scenes simultaneously produces an inordinate bandwidth and compute burden for the viewing client and the connected network, especially as the resolution of a camera source is increased. In such conventional systems, the video source is fixed (i.e., the frame rate and resolution cannot be modified), and a viewing client is incapable of adapting the video source to its environmental constraints. In this regard, the adaptation of a video stream of fixed attributes into an arbitrary viewing space (window) is a scenario that does not provide the proper balance between computer and network resources versus viewing quality and operation. Furthermore, standard single-stream camera sources, such as those employed in the Surveillance industry, are designed such that a configuration change for any of the above parameters affects all viewers irrespective of client viewing capabilities or network capacity (i.e., the behavior is static at the source).

In the practice of the disclosed systems and methods, a video delivery system may be provided that includes one or more video source components in combination with one or more client viewing applications. In such an embodiment, a video source component may be configured to produce video streams of multiple different combinations of rates and resolutions (e.g., two or more different combinations of rates and resolutions, three or more different combinations of rates and resolutions, etc.), and a client viewing application may be configured to understand the multi-stream capabilities of the aforementioned video source component. A client viewing application may be further configured in one embodiment to analyze its own viewing operations and to dynamically select the optimal video stream type/rate based on the results of the analysis. Such an analysis by the viewing client may be based on one or more stream selection parameters including, but not limited to, attributes (e.g., bitrate, frame rate, resolution, etc.) of video streams available from a video source, local viewing window resolution for the associated video stream, the number of input video streams in combination with the number of active views, computer resource status (e.g., memory availability, compute load, etc.), network bandwidth load, resource status of the video source, one or more configured policies regarding viewing operations, combinations thereof, etc.

In one embodiment, disclosed herein is an interactive video delivery system that includes a video source and/or video source and/or coupled video access component that provides multiple (greater than one) video streams of a given scene, and an intelligent viewing client that analyzes viewing operations and/or viewing modes and dynamically selects the optimal video stream/s provided by the video source in a manner that provides optimized (e.g., optimal) bandwidth and compute utilization while maintaining the appropriate video fidelity. In such an embodiment the video source, and/or a video access component coupled thereto, may be configured to advertise (e.g., using either standard or proprietary methods) information concerning the rates, resolutions, and viewing aspects (i.e., aspect ratio, spatial orientation, viewing geometry, etc.) of the available video streams related to a given scene/source (camera, etc.). The viewing client may be configured to select an optimized stream rate/s (e.g., optimal stream rate/s) for viewing the video data based at least in part on the information advertised by the video source and/or video access component. The viewing client may also be configured to perform this selection based further in part on one or more viewing operations selected by the user and/or by configuration. In another embodiment, a viewing client may also be configured to select an optimized stream frame rate and/or resolution by performing an analysis in which it selects the optimal stream rate/s and/or resolutions in an adaptive fashion (i.e., adapted to current video delivery operating conditions and/or currently specified video modes) for viewing the video data. This adaptive selection process may advantageously be performed in a dynamic, real-time manner.

In one respect, disclosed herein is a method of controlling display of at least two video streams over a network connection, including: analyzing video capabilities of a multi-stream video source to determine if the multi-stream video source is capable of providing a first video stream and a second video stream of a high quality region of interest (HQ-ROI) corresponding to the first video stream; accessing the first and second video streams (e.g., via selection of first and second multi-cast video streams, or via selection and specific request for delivery of the first and second video streams, or a combination thereof) from the multi-stream video source for delivery over the network connection; receiving the first and second video streams simultaneously from the multi-stream video source over the network connection; and simultaneously displaying the received first and second video streams.

In another respect, disclosed herein is a method of providing at least two video streams over a network connection for display, including: communicating information over the network connection to a viewing client regarding video capabilities of a video source, the video source being a multi-stream video source capable of providing at least two video streams over the network connection, the at least two video streams including a first video stream and a second video stream of a high quality region of interest (HQ-ROI) corresponding to the first video stream; receiving at least one request over the network connection from the viewing client for the first and second video streams from the multi-stream video source for delivery over the network connection; and then in response to the at least one request, simultaneously communicating the requested first and second video streams from the multi-stream video source to the viewing client over the network connection for simultaneous display.

In another respect, disclosed herein is a method of controlling display of at least two video streams over a network connection, including: analyzing video capabilities of at least one video source to determine if the at least one video source is capable of providing a first video stream and a second video stream of a high quality region of interest (HQ-ROI) corresponding to the first video stream; accessing the first and second video streams (e.g., via selection of first and second multi-cast video streams, or via selection and specific request for delivery of the first and second video streams, or a combination thereof) from the at least one video source for delivery over the network connection; receiving the first and second video streams simultaneously from the at least one video source over the network connection; and simultaneously displaying the received first and second video streams.

In another respect, disclosed herein is a video display system, including a viewing client configured to be coupled to a network connection, the viewing client being further configured to: analyze video capabilities of a multi-stream video source to determine if the multi-stream video source is capable of providing at least a first video stream and at least a second video stream of a high quality region of interest (HQ-ROI) corresponding to the first video stream; access over the network connection the first and second video streams from the multi-stream video source for delivery over the network connection (e.g., via selection of first and second multi-cast video streams, or via selection and specific request for delivery of the first and second video streams, or a combination thereof); receive the first and second video streams simultaneously from the multi-stream video source over the network connection; and simultaneously display the received first and second video streams.

In another respect, disclosed herein is a video display system, including a viewing client configured to be coupled to a network connection, the viewing client being further configured to: analyze video capabilities of at least one video source to determine if the at least one video source is capable of providing a first video stream and a second video stream of a high quality region of interest (HQ-ROI) corresponding to the first video stream; request the first and second video streams from the at least one video source for delivery over the network connection; receive the first and second video streams simultaneously from the at least one video source over the network connection; and simultaneously display the received first and second video streams.

### BRIEF DESCRIPTION OF THE DRAWINGS

FIG. 1 is a simplified block diagram of a video delivery system according to one embodiment of the disclosed systems and methods.

FIG. 2 is a simplified block diagram of a video delivery system according to one embodiment of the disclosed systems and methods.

FIG. 3 is a simplified block diagram of a video delivery system according to one embodiment of the disclosed systems and methods.

FIG. 4 is a flow chart of video stream selection methodology according to one embodiment of the disclosed systems and methods.

FIG. 5 is a simplified block diagram of a video delivery system according to one embodiment of the disclosed systems and methods.

FIG. 6 illustrates display of multiple views/streams by a viewing application according to one exemplary embodiment of the disclosed systems and methods.

FIG. 7 is a flow chart showing logic flow according to one exemplary embodiment of the disclosed systems and methods.

### DESCRIPTION OF ILLUSTRATIVE EMBODIMENTS

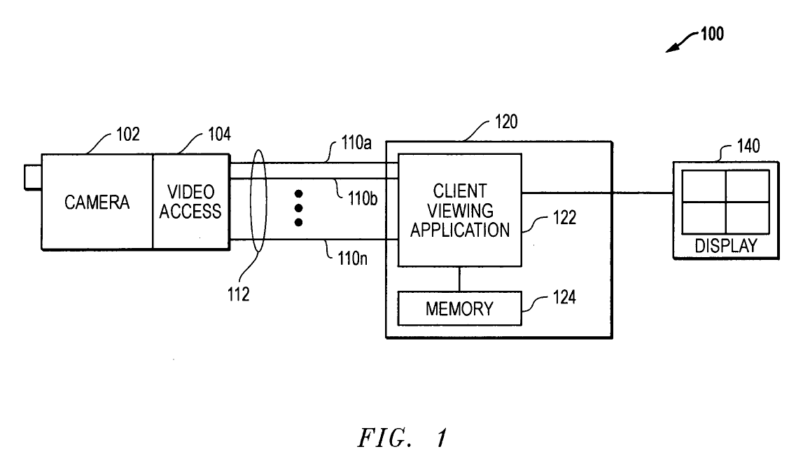

FIG. 1 shows a simplified block diagram of a video delivery system 100 as it may be configured according to one embodiment of the disclosed systems and methods. In this exemplary embodiment, video delivery system 100 includes a video source component or video source device (VSD) 102, a video access component 104, a viewing client 120, and a video display component 140. With regard to this and other embodiments described herein, it will be understood that the various video delivery system components may be coupled together to communicate in a manner as described herein using any suitable wired or wireless signal communication methodology, or using any combination of wired and wireless signal communication methodologies. Therefore, for example, network connections utilized in the practice of the disclosed systems and methods may be suitably implemented using wired network connection technologies, wireless network connection technologies, or a combination thereof.

As shown in FIG. 1, video source component 102 and video access component 104 are integrated together in this exemplary embodiment as a single device, although this is not necessary. In the embodiment of FIG. 1, video source device 102 and video access component 104 may be further characterized as being “closely coupled”, e.g., image hardware components of video source device 102 may be directly coupled to provide digital signals to integrated video access component circuitry of video access component 104 via bus, high speed serial link, etc.

In the exemplary embodiment of FIG. 1, video source 102 is a digital video camera and video access component 104 is a digital video stream server, however it will be understood that in other embodiments a video source may be any other type of device (e.g., analog video camera, digital video recorder, digital video tape deck, streaming media server, video-on-demand server, etc.) that is suitable for producing one or more digital or analog video streams. Furthermore, a video access component may be any device (e.g., digital video encoder, analog-to-digital encoder, analog-to-digital video recorder proxy streaming server/cache, etc.) that is suitable for receiving analog and/or digital video stream information from one or more video sources, and for generating or otherwise providing a single digital video stream, or for providing multiple digital video streams (e.g., of different rates and/or resolutions), that are based on the received video stream information and communicating these digital video stream/s across a computer network medium (e.g., via packet-based network, serial network, etc.). It will also be understood that a separate signal conversion component may be present to convert an analog video stream received from an analog video source to a digital video stream for communication across a computer network medium.

A video access component may be configured, for example, to perform advertisement of stream attributes, to perform session management tasks, and to implement video stream protocols. In this regard, examples of video access components include, for example, devices that take analog input signals and convert them to digital formats and which may also encode signals using any suitable format/protocol (e.g., known video compression format/protocol), as well as devices of any configuration that are capable of converting/transcoding (e.g., frame rate adaptation and/or scaling) or forwarding video streams.

It will be understood that a video access component need not be present between a given video source/s and a viewing client, i.e., one or more video streams may be provided from a video source to a viewing client over one or more network connections in any alternative suitable manner. Therefore, for purposes of this disclosure, a video stream/s may be considered to be provided from a video source and received by a viewing client from the video source over one or more network connections whether or not the video stream/s is transferred from the video source/s to the viewing client through a video access component. Furthermore, the session management functions of a video access component may be logically implemented in any suitable configuration, whether it is as a stand alone device or system, integrated component of another device or system, or implemented by more than one device or system.

Still referring to FIG. 1, video access component 104 is coupled to communicate multiple digital video streams 110a to 110n across computer network medium 112, to a viewing client 120. Network medium 112 may be a packet-based network (e.g., TCP/UDP/IP, IPX/SPX, X.25, etc.), or a serial network (e.g., ISDN, DS0/DS1/DS3, SONET, ATM, etc.). Each of multiple video streams 110 may represent, for example, a different combination of video rate and video resolution of a single scene, or a spatial subset thereof (via extraction), that is captured by video source 102 and provided to video access component 104, which performs the video streaming and session management functions for video source 102. For example, video source 102 may be a multi-stream (e.g., dual rate) digital video camera, or may be a digital video camera that includes encoders for providing three or more digital video input streams to video access component 104 for delivery across network medium 112 in the form of protocol compliant video streams 110. As shown, viewing client 120 is in turn configured to provide video image data based on video streams 110 to video display component 140, e.g., as multiple windows for viewing by a user on video display component 140. In the illustrated embodiment, viewing client 120 includes client viewing application (CVAP) 122 executing on viewing client 120, and coupled to optional memory 124. It will be understood that viewing client 120 may include any combination of hardware and/or software suitable for performing one or more tasks described elsewhere herein, e.g., one or more central processing units (CPUs) or microprocessors and optional memory configured to execute one or more tasks of client viewing application 122 as they will be described further herein. In one exemplary embodiment, viewing client 120 may be a PC-based workstation coupled as network node to network 112, and video display component 140 may be a computer monitor coupled to the PC-based workstation.

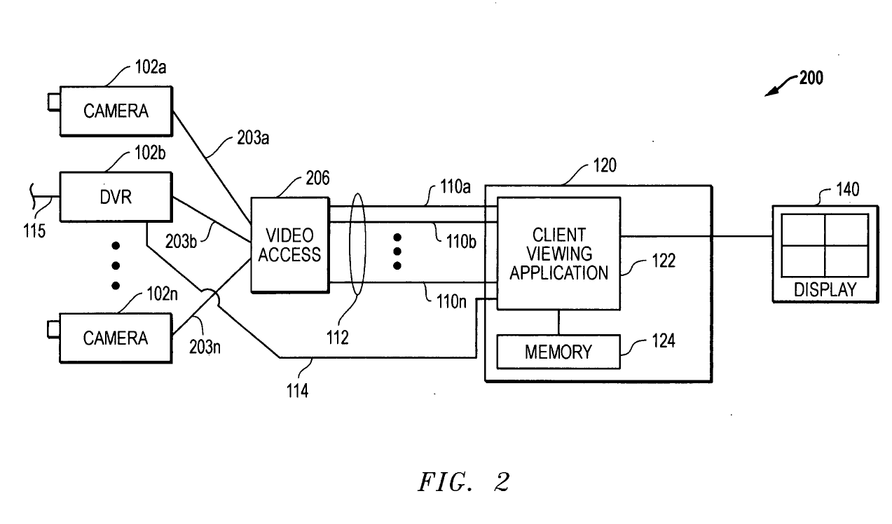

FIG. 2 shows a simplified block diagram of a video delivery system 200 as it may be configured according to another embodiment of the disclosed systems and methods. In this exemplary embodiment, video delivery system 200 includes multiple separate video source components 102a through 102n that are each coupled to deliver one or more analog video streams (e.g., as one or more standard composite video streams) to video access component 206 via a respective dedicated analog signal connection 203a through 203n, as shown. In this exemplary embodiment, video sources 102a and 102n are each analog video cameras, and video source 102b is a digital video recorder (DVR) having an analog signal output (e.g., analog video output loop) coupled to provide an analog video signal over dedicated connection 203b to video access component 206. As shown in FIG. 1, DVR video source 102b may also be optionally coupled to receive analog video input signals 115.

In the embodiment of FIG. 2, video access component 206 contains processing logic to convert the analog video signals 203 into digital video data and scale and encode these input streams into multiple digital video output streams 110. As shown in FIG. 2, it is also possible that digital video data stored in DVR 102b may be optionally provided directly (e.g., bypassing video access component 206) to viewing client 120 in its recorded format using optional network medium communication path 114 e.g., via a video access component integrated within DVR 102b. In this regard, optional network medium 114 may be a separate network connection coupled to viewing client 120 as shown, or may be a network connection that is coupled to provide digital video data to viewing client 120 via network medium 112 (e.g., via shared Ethernet, etc.)

In an alternatively embodiment, multiple separate video source components 102a through 102n may be each coupled to deliver one or more digital video streams to video access component 206 via a computer network (not shown). In such an alternative embodiment, video source 102b may be a DVR that is configured to record and playback digital video data received from one or more other video sources 102 through such a computer network that links video source components 102a through 102n to video access component 206.

As shown in FIG. 2, video access component 206 is coupled to communicate multiple digital video streams 110a to 110n across computer network medium 112 to viewing client 120. Each of multiple video streams 110 may represent, for example, video data provided by one of video sources 102a through 102n at a specific combination of video rate and video resolution. In this exemplary embodiment, it is possible that each of video streams 110 include video data provided by a different video source 102, or that at least two of video streams 110 may include video data provided by the same video source 102, but at a different combination of video rate and video resolution and/or a spatial subset of the overall scene (via extraction). As shown, viewing client 120 is in turn configured to provide video image data based on video streams 110 to video display component 140 in a manner as previously described.

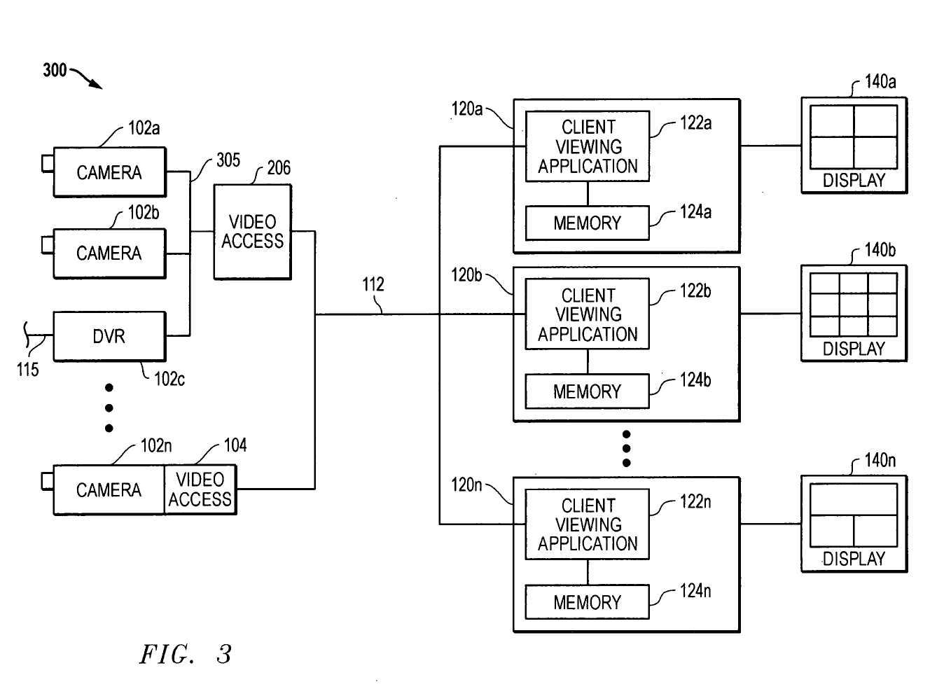

FIG. 3 shows a simplified block diagram of a video delivery system 300 as it may be configured according to yet another embodiment of the disclosed systems and methods. In this exemplary embodiment, video delivery system 300 includes multiple separate video source components 102a through 102n. As shown, video source components 102a, 102b, and 102c (DVR) are each coupled to deliver one or more digital video streams to video access component 206 via a computer network 305. Further, DVR video source 102c may also be optionally coupled to receive analog video input signals 115, and any given one or more of multiple separate video source components 102a through 102c may optionally include an integrated video access component.

In the embodiment of FIG. 3, video source devices 102 and video access component 206 may be further characterized as being “loosely coupled”, e.g., image hardware components of video source devices 102 may be coupled to provide digital signals to video access component circuitry of video access component 206 via computer network medium. In such a case, digital signals provided by video source devices 102 to video access component 104 may be encoded using suitable compression protocol (e.g., MPEG-2, MPEG-4, H.263, H.264, etc.). It will be understood that FIG. 3 is exemplary only, and that video source components 102 may be coupled to provide one or more video streams to video access component 206 using any suitable method, e.g., switched or shared network connection, dedicated connections, etc.

Video access component 206 is configured to receive the input video streams on network medium 305, scale and/or transcode, and/or extract spatial portions of, these streams into various rate and resolution video streams, and, is in turn coupled to communicate these multiple digital video streams (not shown separately in FIG. 3) across computer network medium 112 to multiple viewing clients 120a through 120n, each of which is in turn configured to provide video image data based on the video streams to a respective video display component 140a through 140n. The DVR 102c, for example, may provide one or more video streams representing pre-recorded video data obtained from one or more other video sources (not shown) to video access component 206, in addition to ‘live’ video streams. As shown in FIG. 3, each of viewing clients 120a through 120n is configured as previously described and includes a respective client viewing application (CVAP) 122 and optional memory 124. As further shown in FIG. 3, video delivery system 300 includes at least one additional video source component 102n that is coupled via an integrated video access component 104 to computer network medium 112.

It will be understood that a video access component may be optionally configured in one embodiment to receive at least one first video stream, to decompose (e.g., decode) the first video stream, and to perform scaling and/or rate adaptation and/or spatial extraction tasks on the first video stream in order to provide at least one second video stream that is based on the first received video stream. In such an embodiment, the first video stream may have a first combination of resolution and frame rate, the second video stream may have a second combination of resolution and frame rate, and the first combination of resolution and frame rate may be different than the second combination of resolution and frame rate (i.e., the resolution of the first combination is different then the resolution of the second combination, the frame rate of the first combination is different than the frame rate of the second combination, or both). Therefore, it is possible in one exemplary embodiment that that a single video access component may provide to a viewing client at least two different video streams that are based on a single video stream provided by a single video source to the video access component. Alternatively a single video access component may provide to a viewing client a single video stream that is based on a single video stream provided by a single video source to the video access component. Such a single video stream may be provided to a network with other video streams, e.g., provided by other video source/s and/or video access component/s. In one embodiment, a given video access component may advertise stream attributes of video streams provided by other video access comments to the same network, e.g., in a situation where different video streams of the same scene/image are provided by different video access components.

In each of the embodiments of FIGS. 1 to 3, client viewing application 122 may be configured to select the identity of at least one received video stream 110 for display based at least in part on one or more stream selection parameters. In one embodiment, a stream selection parameter may be a dynamic parameter (i.e., a parameter subject to change during system operations), and client viewing application 122 may adapt to changing system operating conditions by monitoring one or more of such dynamic stream selection parameters that reflect these changing conditions. Such a dynamic parameter may be based, for example, on one or more characteristics of an available video stream/s 110, based on one or more characteristics of a given viewing system hardware and/or software configuration (e.g., video display component 140 usage, processor or memory usage of viewing client 120, user operations on video client 120, etc.), based on requirements of a particular viewing application, etc. Specific examples of dynamic stream selection parameters include, but are not limited to, attributes (e.g., bitrate, frame rate, resolution, etc.) of video stream/s 110 currently available from a video source/s, available current local viewing window resolution of video display component 140 for a given associated video stream 110, the current number of input video streams 110 in combination with the current number of active views on display component 140, current resource status (e.g., memory availability, compute load, etc.) of viewing client 120, current bandwidth load of network 112, current resource status (e.g., compute load, memory availability, concurrent number of active video sessions/streams, etc.) of the video source/s 102, etc.

A stream selection parameter may also be a static parameter such as a parameter based on one or more fixed characteristics (e.g., video display component 140 capability, processor or memory capabilities of viewing client 120, etc.) of a given viewing system hardware and/or software configuration, or a user-specified or pre-programmed default policy parameter, etc. Specific examples of static stream selection parameters include, but are not limited to, maximum local viewing window resolution of video display component 140, maximum resource capability (e.g., total memory, total compute capability, etc.) of viewing client 120, maximum bandwidth capability of network 112, maximum resource capability of the video source/s 102, one or more configured policies, maximum number of active video streams allowed at video client 120, maximum bandwidth allowed to be processed by video client 120, predefined spatial areas for ROIs within a scene, etc.

In one exemplary embodiment a static stream selection parameter may be a configured or pre-programmed static stream selection policy that acts to constrain one or more operating characteristics of a video delivery system. One example type of static stream selection policy is a policy that specifies maximum allowable total video stream bandwidth (i.e., total bandwidth of all selected video streams) to be delivered over network 112 to a viewing client 120 at any given time. Another example type of static stream selection policy is a policy that specifies maximum allowable processor (compute) resource usage of viewing client 120 for a given combination of selected video streams displayed on a video display component 140. For example, a stream selection policy may specify a maximum allowable processor usage of about 50% for a four window Standard Interchange Format (SIF)-15 display (e.g., four 352H by 240V pixel windows displayed at 15 frames per second) on video display component 140 as shown in FIG. 1.

Another example type of static stream selection policy is a policy that specifies selected video stream resolutions for a given viewing mode, i.e., the given configuration of one or more video windows of given spatial resolution to be displayed on video display component 140. In this regard, a policy may specify that video stream resolution/s be selected to match specified spatial resolution/s of one or more display windows to be provided for display. For example, a static stream selection policy may specify that nine equally-sized windows always be displayed at SIF-15 (e.g., nine 352H×240V rectangular pixel or 320H×240V square pixel windows displayed at 15 frames per second) on video display component 140b in FIG. 3. In yet another example, a static stream selection policy may specify that sixteen equally-sized windows always be displayed at Quarter Standard Interchange Format (QSIF)-15 (e.g., sixteen 176H by 120V rectangular pixel or 160H×120V square pixel windows at 15 frames per second) on a video display component 140 (not shown). In this regard, network bandwidth for displaying any such combination of video streams is determined by the resolution of the video streams selected for display, such a policy may be implemented, for example, as a way to control total network bandwidth required to display the video streams.

In another example, a static stream selection policy may be implemented to help reduce video artifacts by specifying that client viewing application 122 always scale down a video stream (rather than scale up the video stream) to fit available window space on video display component 140. In this regard, given an available window area of 240H×180V square pixels in combination with a video stream having a SIF of 320H×240V square pixels (QSIF of 160H×120V square pixels), a static stream selection policy may specify that client viewing application 122 always scale the video stream down to fit the available window area. In yet another example, a static stream selection policy may specify that client viewing application 122 always select lower video resolutions for relatively smaller-sized display windows in order to save bandwidth of network 112.

It will be understood that the preceding static stream selection policies are exemplary only, and that other policies and/or combinations of such policies may be implemented. For example, another type of stream selection policy may specify that the highest frame rate available video stream/s always be selected that may be displayed (regardless of resolution) without exceeding compute resources or network bandwidth capacity of the viewing client component. Such a policy may be desirable where fast frame rate is more important than resolution, e.g., such as in a casino surveillance operation where detection of quick movements is important. Alternatively, a stream selection policy may specify that the optimal or highest resolution available video stream/s always be selected that may be displayed (regardless of frame rate) without exceeding compute resource or network bandwidth capacity, e.g., in a situation where detection of fine details is more important than detecting quick movement. In another example, a static stream selection policy may specify that the lowest resolution available video stream/s always be selected or that the lowest frame rate available video stream/s is always selected, regardless of compute resource or network bandwidth capacity. Such policies may be desirable, for example, where preserving network bandwidth and/or computer resource capacity is most important.

In one embodiment of the practice of the disclosed systems and methods, stream selection parameters may be processed by client viewing application 122 in a manner that optimizes video quality relative to system operating efficiency, or vice-versa. In this regard, a stream selection policy may be implemented that specifies that video quality (e.g., resolution, frame rate, etc.) always be maximized at the expense of system operating efficiency (e.g., network bandwidth, compute resource usage, etc.). Alternatively, a stream selection policy may be implemented that specifies that system operating efficiency always be maximized at the expense of video quality. In yet other examples, a stream selection policy may trade-off or balance between video quality and system operating efficiency under particular conditions.

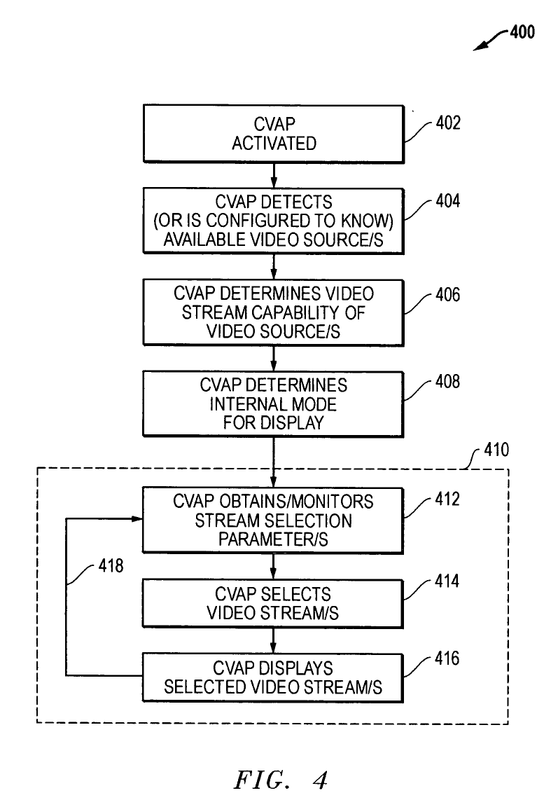

FIG. 4 is a flow chart illustrating one exemplary embodiment of video stream selection methodology 400 that may be implemented using the disclosed systems and methods, for example, in conjunction with a video display system 100, 200 or 300 of FIG. 1, 2 or 3, respectively. Video stream selection methodology 400 begins in step 402 with activation of CVAP 122. Upon activation, CVAP 122 either detects the identity of available video source/s 102 (e.g., via Service Location Protocol (SLPv2 RFC 2608) or LDAP or UPnP, etc.), or may be configured to know the identity of available video source/s 102 in step 404 (e.g., by directly entering a fixed network domain name or IP address). Next, in step 406, CVAP 122 determines the video stream capability (i.e., via Session Description Protocol (SDP, RFC 2327) or Session Initiation Protocol (SIP, RFC 2543) or H.245, etc.) of the video source/s 102 identified in step 404. CVAP 122 may determine the video steam capability of the video source/s 102 in any suitable manner, for example, by querying video source/s 102 for video stream information (e.g., using RTSP/SDP, etc.) and/or receiving video stream information advertised by video source/s 102 (e.g., using SLP, H.225/H.245, etc.) and/or video access components 104 or 206 in a manner similar to that described below in relation to obtaining stream selection parameters in step 412.

Following determination of video source/s identity and video steam capability in steps 404 and 406, CVAP 122 may determine internal viewing mode for display component 140 (i.e., based on the client viewing application's feature set and viewing capabilities) in step 408. Examples of internal viewing mode information include, but are not limited to, the types of screen layouts available for viewing, the decoding and screen rendering capabilities of the application and its hardware, the types of viewing functions supported by the client viewing application, video window attributes, the presence of video graphics hardware that offloads buffering and video scaling, operating system type/version information, available system memory, hardware display type and attributes (spatial resolution, aspect ratio, color resolution), etc. In this regard, internal viewing mode information may be obtained by CVAP 122, for example, by reading application specific configuration information from an operating system registry or from a file, by retrieving system policy information, regarding allowable functions and operation from a network attached server, etc.

Following steps 402 through 408, CVAP 122 may execute video stream selection and display logic 410, in this exemplary embodiment by implementing steps 412 through 416. As shown in FIG. 4, CVAP 122 may obtain and monitor video stream selection parameter information in step 412. In one embodiment, this video stream selection parameter information may include one or more attributes of video streams available from the video source/s 102 identified in step 406. In this regard, CVAP 122 may obtain and monitor video stream selection parameter information from video source/s 102 in any suitable manner. For example, CVAP 122 may query an identified video source/s 102 for stream selection parameters using, for example, Real Time Streaming Protocol/Session Description Protocol (RTSP/SDP) or any other suitable querying protocol. In response, the queried video source/s 102 may respond with attribute information (e.g., video rates and resolution information including bit rate, frame rate and video stream resolution, spatial region definitions for ROIs) concerning digital video streams 110 available from the queried video source 102. Alternatively, a given digital video source 102 and/or video access component 104 or 206 may advertise attributes of available digital video streams to CVAP 122, e.g., using Service Location Protocol (SLP), H.225, or any other suitable protocol. In either case, a single digital video source 102 may indicate to CVAP 122 that it is providing one or more digital video streams of given rate and/or resolution and/or spatial orientation. For example, a video source may indicate to CVAP 122 in step 412 that it is capable of providing a first digital video stream 110a (15 frame per second, 300 kB stream) of a given image, and a second digital video stream 110b (5 frame per second, 100 kB stream) of the same given image. It will be understood that video stream attributes may be advertised multiple times (e.g., updated) during a given session, or may be advertised only once at the beginning of a given session. In either case, a digital video source and/or video access component may respond to a request for a given advertised video stream by indicating that the video stream is currently unavailable or that the video stream attribute/s have changed.

CVAP 122 may also obtain video selection parameters from sources other than video sources 122 in step 412. Such other video selection parameters include, but are not limited to, those parameters previously mentioned. For example, information concerning local viewing window resolution of video display component 140 for a given video stream 110 may be obtained by reading/querying parameters associated with the dimensions and aspect ratio of each individual viewing window. The number of active views being displayed on video display component 140 may be obtained, for example, by reading/querying screen layout/geometry parameters that indicate the number of, location of, and type of video windows per screen layout along with associated input stream parameters. Video display processor resource status (e.g., memory availability, compute load, etc.) of viewing client 120 may be obtained, for example, by querying operating system functions that provide CPU and memory utilization information or by using internal processing statistics. Bandwidth load of network 112 may be obtained, for example, by querying/reading network layer statistics or by analyzing data available in the video transport protocols that indicate latencies and data/packet loss or by analyzing I/O (interrupt, scheduling, and event) rates within the system. Resource status of video source/s 102 may be obtained, for example, by querying/reading statistics from video source/s 102 or from receiving periodic real-time status updates from video source/s 102.

In addition, one or more configured video selection policies may be obtained, for example, by reading configured policy information from a system registry or file, or by mapping specific screen layouts to specific policy parameters that govern video selection criteria. As will be described further herein, such video selection policies may be, for example, any user-specified or system default rule that may be employed in combination with one or more other video selection parameters to govern the selection of particular available video streams 110 for display on video display component 140.

Next, in step 414, CVAP 122 selects particular video stream/s from the available video streams determined in step 412, e.g., based on one or more stream selection parameters obtained in step 412. This selection process may be performed using any suitable analytical or computational logic (e.g., state machine logic, if-then-else logic, switch-case statement logic, real-time computation or analytical logic, lookup table logic, etc.). In step 416, CVAP 122 then displays the selected video stream/s on video display component 140 in accordance with internal viewing display modes determined in step 408. Video stream selection and display logic 410 may then continue by repeating steps 412 through 416 during the video delivery process, as indicated by arrow 418. As described elsewhere herein, CVAP 122 may analyze a variety of dynamic stream selection parameters (e.g., parameters related to system, network, and resource states), alone or in various combinations, to determine the optimal viewing stream selected for a given video display mode. It is also possible that configuration data regarding limits, modes, etc., may also be factored into any analysis performed. In one example dynamic adaptation to changing conditions may be achieved, e.g., for a given resolution of a single viewing mode, the frame rate may be changed upon detection of a change in computer resource load or network traffic. For example, the frame rate may be dropped as necessary to maintain a given resolution upon an increase in compute resource load or increase in network bandwidth load.

As described above, state machine logic is one type of logic that may be employed in the practice of video stream selection methodology according to the disclosed systems and methods. The use of state machine logic to define the logic flow for each viewing mode is not necessary, but may be implemented in a manner that is very efficient and flexible with respect to the ability to easily add per-state/substate logic in order to handle any additional parameter analysis (i.e., memory availability, network load, I/O rates, response times, etc.) that may be deemed necessary. In this regard, state machine logic may implemented in a manner that simplifies stream selection logic by forcing the selected active, incoming video stream type to be conditionally or directly associated with default window size of each specific viewing mode, e.g., as a static association performed within each viewing mode. Thus, any user operations resulting in a change in viewing modes dynamically triggers viewing stream re-analysis. However, in other embodiments, logic that counts the number of active display windows rather than analyzing states, or that simply analyzes compute resource loading, for example, may be alternatively employed.

In one embodiment, a state machine logic approach may be based on the current viewing mode in order to simplify the analysis and processing logic while providing flexibility for more static (pre-programmed, configuration driven) or more dynamic (complex parameter analysis) driven analysis modes. In one example of such an embodiment, each of the logic paths of the state machine may be configured to always attempt to display the video stream that most closely matches the geometric dimensions of the corresponding display window in order to reduce local compute loads and network bandwidth demands, while providing the highest-quality viewing experience by minimizing, or obviating, the need to scale a video stream into the target viewing window's display dimensions.

Table 1 illustrates exemplary client viewing modes that may be obtained from, for example, basic application configuration information and/or derived by analyzing the display capabilities of a system. As previously described, CVAP 122 may determine the client viewing modes in step 408 of FIG. 4.

TABLE 1

| VIEW | | |
|---|---|---|
| MODE | WINDOW SIZE/ | |
| NAME | WINDOW COUNT | DESCRIPTION |
| SingleView/ | 1280 H × 960 V/1 Window | Single large viewing |
| Big Mode | | window |
| 4-Way Grid | 640 H × 480 V/4 | 2 × 2 Grid of 640 H × 480 V |
| | Windows | viewing windows |
| 9-way Grid | 426 H × 320 V/9 | 3 × 3 Grid of 426 H × 320 V |
| | Windows | viewing windows |
| 16-way Grid | 320 H × 240 V/16 | 4 × 4 Grid of 320 H × 240 V |
| | Windows | viewing windows |
| 25-way Grid | 256 H × 192 V/25 | 5 × 5 Grid of 256 H × 192 V |
| | Windows | viewing windows |

Table 2 illustrates exemplary stream selection parameters in the form of characteristics of video streams, e.g., such as may be available from video source/s 102 of FIGS. 1-3. As previously described, CVAP 122 may determine such stream selection parameters in step 412 of FIG. 4.

TABLE 2

| | IMAGE | | APPROXIMATE | |
|---|---|---|---|---|
| STREAM NAME | RESOLUTION | FRAME RATE | BIT RATE | |
| 16SIF-15 | 1280 H × 960 V | 15 fps | 20 | Mbps |
| 16SIF-5 | 1280 H × 960 V | 5 fps | 6.7 | Mbps |
| 4SIF-30 | 640 H × 480 V | 30 fps | 3 | Mbps |
| 4SIF-15 | 640 H × 480 V | 15 fps | 1.5 | Mbps |
| SIF-30 | 320 H × 240 V | 30 fps | 750 | Kbps |
| SIF-15 | 320 H × 240 V | 15 fps | 375 | Kbps |
| SIF-5 | 320 H × 240 V | 5 fps | 125 | Kbps |
| QSIF-15 | 160 H × 112 V | 15 fps | 96 | Kbps |

Following is a description of an exemplary state machine logic that may be employed using the information of Tables 1 and 2 to implement video selection methodology according to one exemplary embodiment of the disclosed systems and methods. As previously described, a CVAP 122 may determine client viewing modes listed in Table 1 from internal application-based parameters, configuration information, and/or any other suitable method. A CVAP 122 may also contact and connect with a video source device 102 over network 112 and, using either a well-known protocol (e.g., such as RTSP/SDP (RFCs 2326/2327) or H.245) or other suitable method, the CVAP 122 may discover the available stream types and stream selection parameters (in this case, available video stream characteristics) as listed in Table 2.

Using the following state machine logic, CVAP 122 may then dynamically select video stream/s for display based on a combination of current client viewing mode and determined stream selection parameters. For example, in this case CVAP 122 may dynamically select which video stream/s (i.e., of given SIF resolution and 5, 15 or 30 frame per second frame rate) for display based on current client viewing mode (i.e., Big Mode or single window viewing mode, 4-Way Grid or four window viewing mode, 9-Way Grid or nine window viewing mode, 16-Way Grid or sixteen window viewing mode, or 25-Way Grid or twenty-five window viewing mode in this example) in combination with stream a selection parameter of compute load (i.e., computer processor resource utilization) and/or the use of network-related statistics related to network resource utilization and data reception:

```
Switch ( Viewing_Mode )
{
  Case Single View/Big Mode:
      If ( compute-load is <= %60 AND network-is-not-losing-data )
          Subscribe and display 16SIF-15 stream;
      Else
          Subscribe and display 16SIF-5 stream;
      EndIf;
  Case 4-Way Grid:
      If ( compute-load is <= %80 )
          (Re)connect all active streams to 4SIF-30;
      Else If ( 4SIF-15 is available )
          (Re)connect all active streams to 4SIF-15;
      Else
          (Re)connect all active streams to SIF-30;
      EndIf;
  Case 9-Way Grid:
      If ( compute-load is <= %70 )
          (Re)connect all active streams to SIF-30;
      Else If (compute-load <= %80 )
          (Re)connect all active streams to SIF-15;
      Else
          (Re)connect all active streams to SIF-5;
      EndIf;
  Case 16-way Grid:
      If ( compute-load is <= %70 )
          (Re)connect all active streams to SIF-15;
          /* Total
      Else If (compute-load <= %80 )
          (Re)connect all active streams to SIF-5;
      Else
          (Re)connect all active streams to QSIF-15;
      EndIf;
  Case 25-way Grid:
          (Re)connect all active streams to QSIF-15;
} // End of Switch logic
```

Whether in multi-window viewing mode or in single window viewing mode, the disclosed systems and methods may be advantageously implemented to dynamically select video stream/s for display based on a combination of current client viewing mode and determined stream selection parameters. For example, in single window viewing mode, video stream selection may be dynamically performed according to the disclosed system and methods upon occurrence of one or more re-sizings of the single viewing window by a user.

It will be understood that the term ‘video stream’ is used herein as a logical term. In this regard, a ‘video stream’ identifies one or more video images, transferred in a logical sequence, that share the same basic attribute, for example, attributes of frame resolution, frame rate, and bit rate. However, it will also be understood that images of a video stream may also share other types of attributes, e.g., a series of video images transferred over the same network connection (‘socket’), a series of video images associated with the same source device or file/track, a series of video images that all share the same timespan, a series of video images that are all associated with the same event or set of events, a series of video images that are all within the same specific timespan from the same video source, etc. In this regard, it is not necessary that there be a direct correlation between a specific network connection or session used to transfer video data and a particular video stream.

In the practice of the disclosed systems and methods, a video source may be configured to provide multiple video streams, and the ability to switch between these video streams in a real-time manner. In this regard, video stream ‘switching’ may be performed in any suitable manner. However, in one embodiment it may be desirable that the a video source be configured to reconfigure, reselect, setup, reconnect, and re-assign video streams in a manner such that there is no detectable disruption of video data at the CVAP. Following are three exemplary manners in which a video source may accomplish video ‘switching’, it being understood that any other suitable methods are also possible.

In one exemplary embodiment, a video source may supply individual video streams on corresponding respective different individual logical network connections (e.g., different TCP/UDP/IP ‘sockets’) that are negotiated between the video source and the CVAP. In one example, Unicast RTSP/RTP protocol may be employed for this purpose. A CVAP may implement a ‘Connect/Disconnect/Reconnect’ method to communicate with a video source to switch between video streams. In this exemplary embodiment, a network connection is equivalent to an individual video stream. A signaling/management/control protocol (e.g., such as RTSP/SDP (RFCs 2326/2327), SIP (RFC 2543), H.225/H.245, etc.) to manage these processes may be necessary in some cases.

In another exemplary embodiment, a single (possibly persistent in one embodiment) network connection (e.g., a single socket) may be enabled to dynamically transfer multiple logically separate video streams. In one example, an HTTP-like or tunneling protocol may employed for this purpose. A CVAP may signal the video source when to change the video stream within the single network connection, using a signaling/management/control protocol (e.g., such as HTTP URL management/URL aliasing, RTSP Interleaved mode, etc.) and the video stream may be changed within the data (packet transport with payload identifier) transferred within the network connection. In such an embodiment, no Connect/Disconnect/Reconnect activity is required.

In yet another exemplary embodiment, various video streams may be distributed across a network on multicast connections (e.g., using multiple multicast sockets) and a CVAP, on its own, may switch to the reception of the available multicast connection/s that supports a desired or selected video stream without any negotiation required with the video source/s. In one example a RTP Multicast protocol may be employed for this purpose.

In the practice of the disclosed systems and methods, multi-stream HQ-ROI viewing capability may be implemented with a video delivery system that includes any suitable combination of one or more video source/s and/or one or more video access component/s coupled to deliver two or more video streams to one or more viewing clients via a network medium. For example, as previously mentioned, a video source component and video access component may be separate components or integrated together as a single device, e.g., camera and stream server components may be one device. Alternatively, a video access component may not be present between a given video source/s and a viewing client, and one or more video streams may be provided from a video source to a viewing client over one or more network connections in any alternative suitable manner such as, for example, as video streams distributed across a network on multicast connections (e.g., using multiple multicast sockets) as previously described. Examples of suitable video system embodiments include, but are not limited to, those embodiments illustrated and described in relation to FIGS. 1-3 herein.

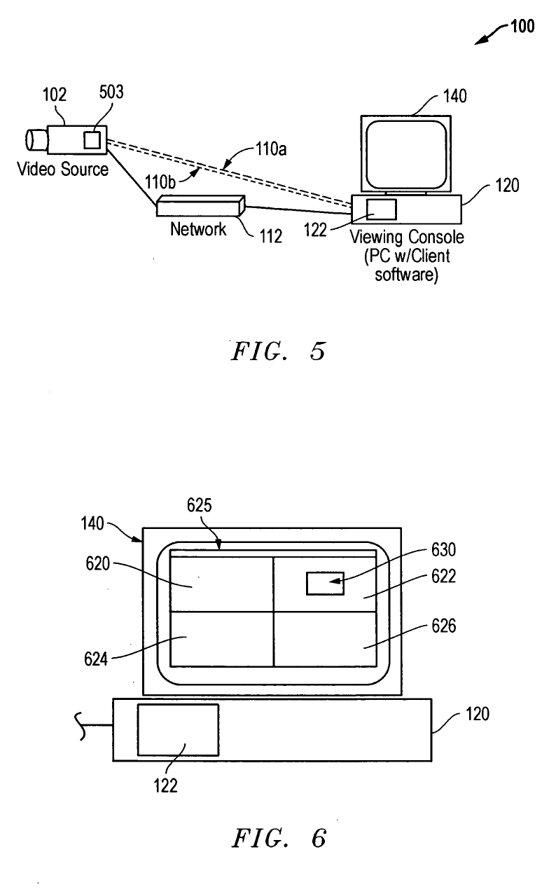

FIG. 5 illustrates how a multi-stream HQ-ROI scenario may be configured in one exemplary embodiment to operate within the context of a video delivery system 100 configured according to one exemplary embodiment of the disclosed systems and methods. In the exemplary embodiment of FIG. 5, a video source 102 in the form of a digital multi-stream camera device is connected to a network 112, and a viewing client 120 in the form of a Personal Computer (PC) viewing console with a client viewing application (software) 122 executing thereon is also connected to the network 112. In this exemplary embodiment, a video display component 140 is shown coupled to the PC of viewing client 120, and viewing client 120 is configured to receive and process multiple video streams (including logical persistent full scene video stream 110a and logical HQ-ROI video stream 110b represented by dashed lines in FIG. 5) that are communicated across computer network medium 112 from video source 102, and to provide video image data based on these multiple video streams to video display component 140, e.g., as windows for viewing by a user on video display component 140.

In the embodiment of FIG. 5, video source 102 may be configured to provide video streams 110a and 110b to network 112 without the presence of a video access component, e.g., as video streams distributed across a network on multicast connections (e.g., using multiple multicast sockets). However, it will be understood that multi-stream HQ-ROI viewing capability (e.g., as described below in relation to FIG. 5) may be implemented with other types of video sources, video access components, viewing clients, and/or video delivery system configurations (e.g., including video delivery system configurations that include separate and/or integrated video access components such as illustrated and described in relation to FIGS. 1-3).

For example, it is possible that a viewing client may select from, receive and simultaneously display multiple video streams provided by two or more different video sources across a network medium, e.g., a first (base) video stream that is provided by a first video source (e.g., relatively lower resolution video camera) across a network medium, and a second (HQ-ROI) video stream that is provided across the same network medium by a second video source (e.g., relatively higher resolution video camera such as “hi-res” video camera), or two or more video sources providing separate video streams of relatively different video compression (e.g., first video source of relatively higher video compression ratio and second HQ-ROI video source of relatively lower video compression ratio). Examples of such multi-video source system embodiments include, but are not limited to, those illustrated and described in relation to FIGS. 2 and 3 herein.

The video source 102 of FIG. 5 may be configured in one exemplary embodiment to provide video streams using a common video protocol (e.g., such as MPEG-2 or MPEG-4) and a protocol for advertising (e.g., such as SLP or SDP) its video stream attributes (parameters), e.g., using methodology described herein in relation to step 406 of FIG. 4. In this exemplary embodiment, video source 102 is a high resolution device (e.g., a 1280H×720V image format) with scaling and spatial windowing (extraction) logic 503 so that it is capable of providing streams in various resolutions. Such windowing and scaling logic may be provided, for example, as logic present in video source 102 (as shown), or may be provided as part of an optional video access component 104 that may be present (e.g., as a separate component or integrated with video source 102) between video source 102 and network medium 112 in a manner as illustrated and described in relation to FIGS. 1-3. As an illustrative example, video source 102 may be configured to provide 1280H×720V, 640H×360V, and/or 320H×180V image resolutions for video streams. Additionally, spatial windowing (extraction) logic 503 of video source 102 may be configured to extract a region of the native image, in real-time, as a ‘window’ (i.e., a spatial subset) of the hi-res (1280H×720V) image, and stream this region of the overall image as its own stream; a native, localized, hi-res stream. In one exemplary embodiment, spatial windowing (extraction) logic 503 (‘windower’) may be capable of extracting an image window (region) up to 320H×180V in size, although extracted windows of greater or lesser size are also possible in the practice of the disclosed systems and methods.

In the exemplary system configuration of FIG. 5, the client viewing application 122 may be configured to detect or know that the video source 102, and/or a video access component coupled thereto, is capable of supplying a video stream consisting of a 320H×180V window, of native resolution (i.e. not down-scaled) within the boundaries of the native 1280H×720V image, e.g., using methodology described herein in relation to step 404 of FIG. 4.

In one exemplary embodiment, video source 102 may be configured to accept commands (e.g., ‘Pan and Tilt’ commands) that allow the client viewing application 122 to move the spatial coordinates of the 320H×180V HQ-ROI view/stream around within the scene. For example, consider an HQ-ROI window/stream that has the starting [X,Y] coordinates of [480,270] which places the initial 320H×180V window in the center of the scene (using upper-left origin coordinates). By decreasing the X coordinate values, the window effectively moves to the left, spatially; by increasing the X coordinate values (to a maximum of 960<1280-320>), the window effectively moves to the right. The same effects are also true for the Y coordinates. Increasing the Y coordinate values (up 540 maximum <720-180>), moves the window down, spatially. Decreasing the Y coordinate values moves the HQ-ROI window/stream up effectively. This basically renders a valid range of values for X of 0 to 960, and a valid range for Y of 0 to 540. By manipulating these coordinate values, the client viewing application may not only request and setup a stream for viewing a higher quality section of a scene, at reduced bandwidth and compute requirements than the full image, but the application may also move the HQ-ROI window around, spatially, within the overall scene allowing the viewer to get a much higher fidelity view of the areas of interest.

In the practice of the disclosed systems and methods, an HQ-ROI view/stream may be spatially moved in any suitable manner, e.g., using control commands. For example, in one embodiment a coordinate system methodology may be implemented in which the client viewing application 122 provides coordinates that are centered within the HQ-ROI viewing window, not based on an upper-left origin. For example, in this exemplary embodiment, the range of valid coordinate values for X may be 160 (320/2) to 1120 (1280−(320/2)) and the valid range of values for Y coordinates may be 90 (180/2) to 630 (720−(180/2)).

In the two previously mentioned exemplary coordinate manipulation methods, absolute coordinate values may be provided as parameters for controlling the spatial placement of an HQ-ROI view/stream; this requires the client viewing application 122 to understand both the absolute dimensions of an image and the absolute dimensions of the HQ-ROI view.

In an alternate embodiment, the client viewing application 122 may supply the coordinate values of X and Y as percentage values, or any form of proportional/ratio values, of spatial displacement within the overall image. For example, the client viewing application 122 may issue spatial parameters for X and Y such as (72, 30) which would indicate that the client viewing application 122 desires the placement of the HQ-ROI view to be at %72 of the horizontal distance from the left image boundary and at %30 of the vertical distance from the top image boundary. The resultant coordinates would be [X=922 (1280*0.72),Y=216 (720*0.30)], whether an upper-left, or centered, coordinate system is employed. The use of percentage, or proportional/ratio, values may be so employed to remove the complexity of having to know the absolute dimensions of an image, although there may be the potential for a lack of accuracy in placing an HQ-ROI on an exact set of pixel coordinates. However, since most display windows used for video stream viewing are arbitrarily sized with respect to the attributes of the stream itself, the use of proportional values is particularly advantageous for manipulating and calculating HQ-ROI views.

For example, assume a viewer or other user is receiving a 320H×180V full scene stream and is viewing this stream in a 640H×360V viewing window on the screen device 140. When a viewer/user initiates an HQ-ROI viewing region on the screen 140 somewhere (e.g., by inputting a user command to client viewing application 122 of viewing client 120), the requested HQ-ROI viewing region may actually occupy an application defined subset of the overall view. For example, the HQ-ROI, in this case from a viewer's perspective (i.e., as presented to the user by the application 122), may be a 240H×135V window within the 640H×360V viewing window. This choice of 240H×135V window may left be up to the application 122. In this exemplary embodiment, the aspect ratio for the HQ-ROI matches that of the video source for the math to be consistent with respect to the overall scene. The choice of a 240H×135V window in the example of the previous embodiment is arbitrary, yet the aspect ratio does match that of the video source. The 320H×180V HQ-ROI view/stream may be scaled into the 240H×135V HQ-ROI window to provide a much higher quality view of viewer's chosen region-of-interest. Proportional values in this example may be used for defining the ratio of the HQ-ROI window to the window size of the full scene view/stream and for indicating to the video source the spatial position within the scene of the HQ-ROI view/stream.

In other embodiments, the HQ-ROI view may be of a different geometry, or aspect ratio, than the full scene view (i.e., a 4×3 HQ-ROI view versus a 16×9 full-scene view, etc.). Any change in the geometry/aspect ratio of the HQ-ROI view versus the full scene view just requires the appropriate mathematics for computing spatial location within the full scene. There are numerous permutations and options for performing these types of operations and the prior examples are given only as basic reference examples with the understanding that other methodologies are possible. Further, the preceding examples are presented to aid in further description of the exemplary methods explained hereafter.

Still referring to the exemplary embodiment of FIG. 5, the client viewing application 122 may be configured to understand, via suitable method(s), that the video source 102, and/or a video access component coupled thereto, is capable of supplying multiple (e.g., three) video streams of the same scene in various resolutions, including video streams 110a and 110b shown in FIG. 5. The client viewing application 122 may also be configured to understand, via suitable method(s), that the video source 102, and/or a video access component coupled thereto, is capable of additionally providing an HQ-ROI view/stream of a set of dimensions (e.g., which may be a spatial portion of one of the 110 streams). In one example of exemplary operation of the system of FIG. 5, the client viewing application 122 may select one of the video streams. Although not necessary, the client viewing application 122 may optionally select one of the streams that is a scaled-down version of the full resolution image since most current client applications, PCs, and networks are not conducive to receiving high resolution video streams and, as such, most hi-res streams are provided at greatly reduced frame rates (fps) in order to reduce bandwidth and compute issues. However, it is not necessary in the practice of the disclosed systems and methods that a scaled-down version of the full resolution image be selected.

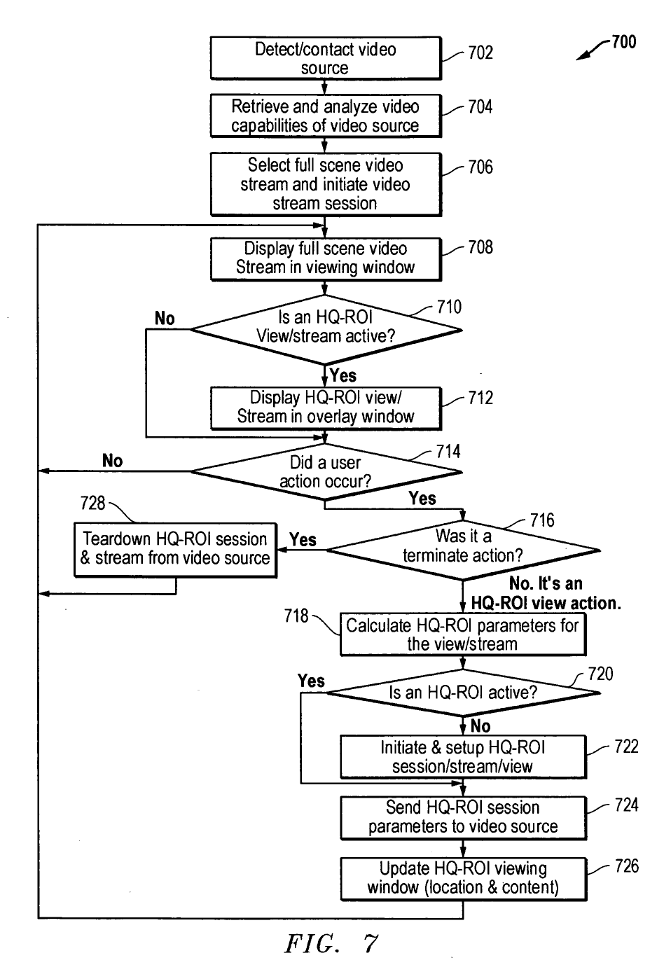

FIG. 6 illustrates how multiple views/streams may be displayed simultaneously on a video display component 140 by a client viewing application 122 of a viewing client 120 according to one exemplary embodiment of the disclosed systems and methods. As depicted in FIG. 6, client viewing application 122 may be configured in one exemplary embodiment to display up to four views/streams simultaneously within an application framework window 625 that includes one, or more interior, individual viewing windows, in this case interior individual viewing windows 620, 622, 624 and 626 displayed as a 4-view (2×2 grid) of four scenes. In this exemplary embodiment, each viewing window 620, 622, 624 and 626 may provide a view of a separate scene (i.e., viewing window=video stream˜=video source). In one exemplary embodiment, the client viewing application 122 may be configured to enable viewer(s)/user(s) to select the scenes (streams) 110 they want to view as windows 620, 622, 624 and 626. Additionally, the client viewing application 122 may be configured to allow viewer(s)/user(s) to ‘click’ on or otherwise designate any area within an active viewing window 620, 622, 624 or 626 such that they can start an HQ-ROI view/stream of the designated area, e.g., area associated with the present location of the viewer/user's mouse pointer icon. In this regard, there are a number of methods available to enable the selection and placement of an HQ-ROI view/stream, and any suitable one of these method/s may be employed.

Subsequent to the selection of an HQ-ROI view, the client viewing application 122 may initiate an HQ-ROI stream 110b from the video source 102 (e.g., see FIG. 5), by supplying the appropriate coordinate parameters, in addition to any other necessary session and/or video related parameters, to the video source 102. The video source 102, and/or a video access component coupled thereto, then may supply an HQ-ROI video stream 110b of the requested view within the overall scene, to the client viewing application 122. Upon receipt of the HQ-ROI stream 110b, the client viewing application 122 may overlay the corresponding area of the viewing window 622 with the HQ-ROI view/stream 1110b such that the window representing the HQ-ROI provides a higher resolution, higher quality view of the area identified by the viewer or other user. In the exemplary embodiment of FIG. 6, the HQ-ROI is shown as a ‘window-within-a-window’ 630; that is, it is a smaller, higher quality window overlaid within a full scene view of a video stream 110a. The viewer/user, in this embodiment, may be enabled to move the HQ-ROI window around, e.g., using a mouse via a standard ‘click and drag’ operation, or any other suitable method, such as use of ‘arrow keys’ for up-down-left-right, a joy stick, etc.

In one embodiment, the client viewing application 122 may be configured to manage one or more video streams 110 in such a manner that each appears within the client viewing application as a single view, in its own individual viewing window, each with a movable, interior, hi-res HQ-ROI window. The HQ-ROI view/stream 110b of this exemplary embodiment is considered to be, but not required to be, a dynamic video stream where dynamic means that this stream may be setup, manipulated, and disconnected in a real-time manner. It is also possible that one or more HQ-ROI views may be statically enabled via the use of preset configuration parameters. As used herein, the referenced video streams are logical. They may be sent over various types of media, including a standard network medium such as Ethernet. In the case of a network medium, the use of standard protocols, such as RTSP/SDP, SIP, HTTP, etc., for session control/management and MPEG-4, or other video compression and transport protocol, are acceptable for use in addition to any other suitable methods. Additionally, video streams may be delivered over individual network connections or multiplexed over a single network connection or using any other suitable method.

Although the preceding exemplary embodiment is oriented towards the dynamic use of an HQ-ROI view/stream, it is possible in other embodiments for HQ-ROI views/streams to be static as pertaining to having persistent views/streams based on predefined coordinate/location parameters, etc.

Furthermore, in one embodiment a video source 102, and/or a video access component coupled thereto, may also have the ability to scale, either dynamically (real-time) or statically, the video content within the viewing dimensions. In such an embodiment, one example method for implementing this capability is for the client viewing application 122 to provide video parameters such that the video source 102, and/or a video access component coupled thereto, knows how to perform the scaling for the addressed scene region(s). One exemplary method for accomplishing this would be for the client viewing application 122 to send the source/origin coordinates of the scene region to be scaled into the HQ-ROI viewing windows dimensions. For example, the client viewing application 122 may indicate to the video source 102, and/or a video access component coupled thereto, to ‘scale’ an origin region of 160H×90V into the prior mentioned 720H×180V viewing window dimensions thus providing a 4× zoom (scale) factor (i.e. each axis of the origin region is scaled 2× thus producing an overall, resultant scaling/zoom factor of 4×[160*90=14,400 pixels, 320*180=57,600 pixels]). Using this method, the client viewing application 122 may dynamically (i.e. in a real-time fashion) manipulate the location and scaling (zoom) factors associated with an HQ-ROI view/stream 110b. In another example, the client viewing application may send the scale/zoom factor to the video source 102, and/or a video access component coupled thereto, along with spatial location information, such that the equivalent operation is achieved. In this case, the video source 102 and/or a video access component coupled thereto, may perform the appropriate math to derive the origin region of interest with respect to the HQ-ROI viewing window dimensions. With benefit of this disclosure, it will be understood by those of skill in the art that there are many other suitable methods for implementing the ability to scale (zoom) the ROI within a scene.

In the practice of the disclosed systems and methods, an HQ-ROI view/stream 110b may be comprised of any set of attributes that enable greater viewing quality with respect to the base, or full scene, viewing stream 110a. In other words, it is possible to send a spatial HQ-ROI region that has the same resolution as the same area within the full scene view but with less video compression and/or an enhanced color format (such as YUV 4:2:2 or YUV 4:4:4) and/or greater pixel definition (such 10-/12-/16-bit pixels) to accomplish additional quality; i.e., not necessarily via the use of high resolution. An example would be a full scene view/stream 10a that is being delivered in YUV 4:2:0-bit format, with a 32× compression ratio, where an HQ-ROI view/stream 110b, of a 720H×180V region, has no additional resolution (i.e., each pixel matches the original pixel), but the format chosen for delivering the HQ-ROI view/stream is YUV 4:2:2 with a 12-bit pixel format, and a compression ratio of 10×. In this case, the quality of the HQ-ROI view/stream 110b is superior to the same region in the full scene view without employing an increase in resolution.

FIG. 7 illustrates one exemplary embodiment of logic flow 700 as it may be ordered to accomplish the viewing and stream management for implementing HQ-ROI viewing at a client viewing application 122. This illustrated logic 700 is purely exemplary and is for each view/stream the client viewing application 122 may manage. It will be understood that there are numerous alternatives to this logic flow, such as having the user drive the selection and detection of the video source 102 and/or a video access component coupled thereto, etc. Logic flow 700 begins in step 702 where client viewing application 122 detects and makes contact with video source 102 and/or a video access component coupled thereto, across network 112. In step 704, client viewing application 122 then retrieves and analyzes video capabilities of video source 102 and/or a video access component coupled thereto, for example, the number of available full scene video streams 110a and/or video stream resolutions that video source 102 or video access component is capable of providing. In step 706, client viewing application 122 selects a full scene video stream 110a, and initiates a video stream session. Client viewing application 122 then displays the selected full scene video stream in a viewing window on video display component 140.

In step 710, client viewing application 122 detects whether or not a HQ-ROI view/stream is active from video source 102, and/or a video access component coupled thereto. If a HQ-ROI view/stream is active, then in step 712 client viewing application 122 displays the HQ-ROI view/stream in an overlay window on the displayed full scene video stream, and then proceeds to step 714 where occurrence of a user action is detected. If no HQ-ROI view/stream is active from video source 102 and/or a video access component coupled thereto, in step 710, then logic flow 700 skips step 712 and proceeds to step 714.

If in step 714 of logic flow 700, client viewing application 122 detects occurrence of a user action (e.g., HQ-ROI viewing action or user termination action), then client viewing application 122 determines in step 716 if the user action is an action to terminate the viewing session. If client viewing application 122 determines in step 716 that the user action is a request to terminate the viewing session, then client viewing application 122 acts in step 728 to teardown the HQ-ROI and/or full scene view/streams from video source 102, and the logic flow 700 returns to step 708. If client viewing application 122 determines in step 716 that the user action is a HQ-ROI view action, then logic flow 700 proceeds to step 718 where HQ-ROI parameters are calculated for the view stream. Then, in step 720, client viewing application 122 checks to determine if a HQ-ROI view/stream is active in step 720 and, if so, logic flow 700 proceeds to step 724 where client viewing application 122 sends calculated HQ-ROI session parameters to video source 102. If no HQ-ROI view/stream is found active in step 720, then a HQ-ROI session is initiated for a HQ-ROI view/stream in step 722 prior to proceeding to step 724. Following step 724, the HQ-ROI viewing window (e.g., location and content) is updated in step 726 according to the parameters sent to video source 102 in step 724. Logic flow 700 then returns to step 708 and repeats.

It will be understood that methodology 700 of FIG. 7 is exemplary only, and that any other suitable combination/s of additional, alternative or fewer steps may be employed, and/or any other suitable but different sequence of given steps may be employed.

The disclosed systems and methods may be implemented to provide numerous benefits related to quality, flexibility, efficiency and adaptability. The quality benefits surround the ability to receive high-quality, high resolution video of an area, or object, without the penalty of having to receive a stream of hi-res images. For example, a viewer may be enabled to see what is necessary in an optimal manner without flooding a network or overloading a client viewing application's compute resources. Additionally, restrictive access scenarios, such as bandwidth limited network connections (wide area networks—WANs, wireless local area networks—WLANs, etc.), secure/encrypted network connection access where only limited throughput is available, or situations where network traffic impinges higher resolution streams, may be resolved by allowing any combination of viewing capabilities necessary via stream selection of full scene views versus HQ-ROI views. These operations may be performed in real-time for flexibility and adaptability to meet a viewer or other user's needs while conforming to environmental constraints, or they may be setup to operate in a static manner which is useful for recording only those areas of significance. Thus, the disclosed systems and methods may be implemented to provide efficiency benefits that are oriented towards bandwidth, compute resource, and/or storage conservation.

In addition to the above, the ability to provide a high-quality view of specific areas of an overall image may be very useful for PC/workstation environments where viewing areas are arbitrarily defined in many cases (by user actions, display attributes, configuration, etc.). In this regard, the disclosed systems and methods may be implemented in one embodiment to allow any arbitrary, full scene video stream to be viewed in any window size, with whatever the resultant quality factor may be, while allowing a high-quality viewing option within the same scene to be available for only a fraction of the compute, memory, and network bandwidth costs.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method of controlling display of at least two video streams over a network connection, comprising:
analyzing video capabilities of a multi-stream video source to determine if said multi-stream video source is capable of providing a first video stream and a second video stream of a high quality region of interest (HQ-ROI) corresponding to said first video stream;
accessing said first and second video streams from said multi-stream video source for delivery over said network connection;
receiving said first and second video streams simultaneously from said multi-stream video source over said network connection; and
simultaneously displaying said received first and second video streams.

2. The method of claim 1, further comprising:
receiving information from said multi-stream video source regarding video capabilities of said multi-stream video source over said network connection; and
analyzing said received information regarding video capabilities of said multi-stream video source to determine if said multi-stream video source is capable of providing said first video stream and said second video stream of a high quality region of interest (HQ-ROI) corresponding to said first video stream.

3. The method of claim 1, further comprising at least partially overlaying said displayed first video stream with said HQ-ROI of said displayed second video stream.

4. The method of claim 1, further comprising displaying said first video stream in a first window; and displaying said HQ-ROI of said second video stream in a second window; wherein said second window is smaller than said first window; and wherein said second window is displayed to overlay said first window.

5. The method of claim 1, further comprising first accessing, receiving and displaying said HQ-ROI of said second video stream as a first spatial subset of said first video stream simultaneously with said first video stream; and then subsequently accessing, receiving and displaying said HQ-ROI of said second video stream as a second spatial subset of said first video stream simultaneously with said first video stream; wherein said second spatial subset is a different spatial subset of said first video stream than said first spatial subset.

6. The method of claim 5, further comprising dynamically manipulating said HQ-ROI by subsequently accessing, receiving and displaying said HQ-ROI of said second video stream as said second spatial subset of said first video stream in response to a user action.

7. The method of claim 5, further comprising controlling said multi-stream video source to provide said accessed HQ-ROI of said second video stream as said first spatial subset of said first video stream, and controlling said multi-stream video source to subsequently provide said accessed HQ-ROI of said second video stream as said second spatial subset of said first video stream.

8. The method of claim 7, further comprising providing a pan-tilt-zoom (PTZ) control command to control said multi-stream video source to subsequently provide said HQ-ROI of said second video stream as said second spatial subset of said first video stream.

9. The method of claim 5, wherein said method further comprises at least one of: zooming said HQ-ROI of said second video stream by controlling said multi-stream video source to change the scaling factor of video images within said second video stream before said multi-stream video source provides said second video stream over said network connection; resizing said HQ-ROI of said second video stream by controlling said multi-stream video source to change the spatial dimensions associated with video images within said second video stream before said multi-stream video source provides said second video stream over said network connection, or a combination thereof.

10. The method of claim 1, wherein said HQ-ROI of said second video stream has at least one of higher resolution, less video compression, enhanced color format or greater pixel definition than said first video stream.

11. The method of claim 10, wherein said HQ-ROI of said second video stream has a higher resolution than said first video stream.

12. The method of claim 1, wherein said video source is coupled to a video access component; and wherein said method further comprises receiving said first and second video streams simultaneously from said video source through said video access component over said network connection.

13. A method of providing at least two video streams over a network connection for display, comprising:
communicating information over said network connection to a viewing client regarding video capabilities of a video source, said video source being a multi-stream video source capable of providing at least two video streams over said network connection, said at least two video streams comprising a first video stream and a second video stream of a high quality region of interest (HQ-ROI) corresponding to said first video stream;
receiving at least one request over said network connection from said viewing client for said first and second video streams from said multi-stream video source for delivery over said network connection; and then
in response to said at least one request, simultaneously communicating said requested first and second video streams from said multi-stream video source to said viewing client over said network connection for simultaneous display.

14. The method of claim 13, further comprising first communicating said HQ-ROI of said second video stream from said multi-stream video source as a first spatial subset of said first video stream simultaneously with said first video stream; and then subsequently communicating said HQ-ROI of said second video stream from said multi-stream video source as a second spatial subset of said first video stream simultaneously with said first video stream; wherein said second spatial subset is a different spatial subset of said first video stream than said first spatial subset.

15. The method of claim 14, further comprising subsequently communicating said HQ-ROI of said second video stream from said multi-stream video source as said second spatial subset of said first video stream in response to a control command received over said network connection by said multi-stream video source from said viewing client.

16. The method of claim 14, wherein said method further comprises subsequently communicating said HQ-ROI of said second video stream from said multi-stream video source as said second spatial subset of said first video stream in response to a pan-tilt-zoom (PTZ) control command received over a network connection by said multi-stream video source.

17. The method of claim 14, wherein said method further comprises at least one of: zooming said HQ-ROI of said second video stream by changing the scaling factor of video images within said second video stream prior to communicating said second video stream from said multi-stream video source to said viewing client over said network connection; resizing said HQ-ROI of said second video stream by changing the spatial dimensions associated with video images within said second video stream prior to communicating said second video stream from said multi-stream video source to said viewing client over said network connection, or a combination thereof.

18. The method of claim 13, wherein said HQ-ROI of said second video stream has at least one of higher resolution, less video compression, enhanced color format or greater pixel definition than said first video stream.

19. The method of claim 18, wherein said HQ-ROI of said second video stream has a higher resolution than said first video stream.

20. The method of claim 13, wherein said video source is coupled to a video access component; and wherein said method further comprises simultaneously communicating said requested first and second video streams from said multi-stream video source to said viewing client through said video access component over said network connection.

21. A method of controlling display of at least two video streams over a network connection, comprising:
analyzing video capabilities of at least one video source to determine if said at least one video source is capable of providing a first video stream and a second video stream of a high quality region of interest (HQ-ROI) corresponding to said first video stream;
accessing said first and second video streams from said at least one video source for delivery over said network connection;
receiving said first and second video streams simultaneously from said at least one video source over said network connection; and
simultaneously displaying said received first and second video streams.

22. The method of claim 21, wherein said method further comprises:
receiving information over said network connection from each of at least two video sources regarding video capabilities of said at least two video sources, each of said video sources being capable of providing at least one video stream over said network connection;
analyzing said received information regarding video capabilities of said at least two video sources to determine if one of said video sources is capable of providing a first video stream, and another of said video sources is capable of providing a second video stream of a high quality region of interest (HQ-ROI) corresponding to said first video stream;
selecting and requesting over said network connection said first stream from a first one of said at least two video sources for delivery over said network connection, and selecting and requesting over said network connection said second stream from a second one of said at least two video source for delivery over said network connection;
receiving said first and second video streams simultaneously from said respective first and second video sources over said network connection; and
simultaneously displaying said received first and second video streams.

23. The method of claim 22, wherein said first and second video sources are coupled to a common video access component; and wherein said method further comprises receiving said first and second video streams simultaneously from each of said first and second video sources through said common video access component over said network connection.

24. The method of claim 22, further comprising at least partially overlaying said displayed first video stream with said HQ-ROI of said displayed second video stream.

25. The method of claim 22, further comprising first accessing, receiving and displaying said HQ-ROI of said second video stream from said second one of said video sources as a first spatial subset of said first video stream simultaneously with receiving and displaying said first video stream from said first one of said video sources; and then subsequently requesting, receiving and displaying said HQ-ROI of said second video stream from said second one of said video sources as a second spatial subset of said first video stream simultaneously with said first video stream from said first one of said video sources; wherein said second spatial subset is a different spatial subset of said first video stream than said first spatial subset.

26. The method of claim 25, further comprising dynamically manipulating said HQ-ROI by subsequently requesting, receiving and displaying said HQ-ROI of said second video stream from said second one of said video sources as said second spatial subset of said first video stream from said first one of said video sources in response to a user action.

27. The method of claim 25, further comprising providing a pan-tilt-zoom (PTZ) control command to control said second one of said video sources to subsequently provide said HQ-ROI of said second video stream as said second spatial subset of said first video stream.

28. The method of claim 25, wherein said method further comprises at least one of: zooming said HQ-ROI of said second video stream by controlling said second one of said video sources to change the scaling factor of video images within said second video stream before said second one of said video sources provides said second video stream over said network connection; resizing said HQ-ROI of said second video stream by controlling said second one of said video sources to change the spatial dimensions associated with video images within said second video stream before said second one of said video sources provides said second video stream over said network connection, or a combination thereof.

29. The method of claim 21, wherein said HQ-ROI of said second video stream has at least one of higher resolution, less video compression, enhanced color format or greater pixel definition than said first video stream.

30. The method of claim 29, wherein said HQ-ROI of said second video stream has a higher resolution than said first video stream.

31. The method of claim 21, wherein said at least one video source is coupled to a video access component; and wherein said method further comprises receiving said first and second video streams simultaneously from said at least one video source through said video access component over said network connection.

32. A video display system, comprising a viewing client configured to be coupled to a network connection, said viewing client being further configured to:
analyze video capabilities of a multi-stream video source to determine if said multi-stream video source is capable of providing at least a first video stream and at least a second video stream of a high quality region of interest (HQ-ROI) corresponding to said first video stream;
access over said network connection said first and second video streams from said multi-stream video source for delivery over said network connection;
receive said first and second video streams simultaneously from said multi-stream video source over said network connection; and
simultaneously display said received first and second video streams.

33. The system of claim 32, wherein said viewing client is further configured to:
receive information over said network connection from said multi-stream video regarding video capabilities of said multi-stream video source; and
analyze said received information regarding video capabilities of said multi-stream video source to determine if said multi-stream video source is capable of providing said at least first video stream and said at least second video stream of a high quality region of interest (HQ-ROI) corresponding to said first video stream.

34. The system of claim 33, further comprising a multi-stream video source configured to be coupled to provide said at least first and second video streams over said network connection in response to a request for said first and second video streams from said viewing client, said second video stream being a high quality region of interest (HQ-ROI) corresponding to said first video stream, and said multi-stream video source being further configured to provide said information over said network connection regarding video capabilities of said multi-stream video source.

35. The system of claim 32, wherein said viewing client is further configured to at least partially overlay said displayed first video stream with said HQ-ROI of said displayed second video stream.

36. The system of claim 32, wherein said viewing client is further configured to display said first video stream in a first window; and to display said HQ-ROI of said second video stream in a second window; wherein said second window is smaller than said first window; and wherein said second window overlays said first window.

37. The system of claim 32, wherein said viewing client is further configured to first access, receive and display said HQ-ROI of said second video stream as a first spatial subset of said first video stream simultaneously with said first video stream; and then to subsequently access, receive and display said HQ-ROI of said second video stream as a second spatial subset of said first video stream simultaneously with said first video stream; wherein said second spatial subset is a different spatial subset of said first video stream than said first spatial subset.

38. The system of claim 37, wherein said multi-stream video source is further configured to communicate said HQ-ROI of said second video stream over said network connection to said viewing client as said second spatial subset of said first video stream in response to a control command received by said multi-stream video source over said network connection from said viewing client; and wherein said viewing client is further configured to dynamically manipulate said HQ-ROI by first accessing, receiving and displaying said HQ-ROI of said second video stream as a first spatial subset of said first video stream simultaneously with said first video stream; and then subsequently accessing, receiving and displaying said HQ-ROI of said second video stream as a second spatial subset of said first video stream simultaneously with said first video stream.

39. The system of claim 37, wherein said multi-stream video source is further configured to subsequently provide said requested HQ-ROI of said second video stream as said second spatial subset of said first video stream in response to a pan-tilt-zoom (PTZ) control command received over a network connection by said multi-stream video source.

40. The system of claim 37, wherein said multi-stream video source is further configured to at least one of:
zoom said HQ-ROI of said second video stream by changing the scaling factor of video images within said second video stream before providing said second video stream over said network connection;
resize said HQ-ROI of said second video stream by changing the spatial dimensions associated with video images within said second video stream before providing said second video stream over said network connection, or
a combination thereof.

41. The system of claim 32, wherein said HQ-ROI of said second video stream has at least one of higher resolution, less video compression, enhanced color format or greater pixel definition than said first video stream.

42. The system of claim 41, wherein said HQ-ROI of said second video stream has a higher resolution than said first video stream.

43. The system of claim 32, wherein said video source is coupled to a video access component; and wherein said viewing client being is configured to receive said first and second video streams simultaneously from said multi-stream video source through said video access component over said network connection.

44. A video display system, comprising a viewing client configured to be coupled to a network connection, said viewing client being further configured to:
analyze video capabilities of at least one video source to determine if said at least one video source is capable of providing a first video stream and a second video stream of a high quality region of interest (HQ-ROI) corresponding to said first video stream;
request said first and second video streams from said at least one video source for delivery over said network connection;
receive said first and second video streams simultaneously from said at least one video source over said network connection; and
simultaneously display said received first and second video streams.

45. The system of claim 44, wherein said at least one video source comprises at least a first video source and a second video source; and wherein said viewing client is further configured to:
analyze video capabilities of said first and second video sources to determine if said first video source is capable of providing said first video stream and said second video source is capable of providing said second video stream of a high quality region of interest (HQ-ROI) corresponding to said first video stream;
access over said network connection said first video stream from said first video source for delivery over said network connection, and request over said network connection said second video stream from said second video source for delivery over said network connection;
receive said first and second video streams simultaneously from said respective first and second video sources over said network connection; and
simultaneously display said received first and second video streams.

46. The method of claim 44, wherein said first and second video sources are coupled to a common video access component; and wherein said viewing client is further configured to receive said first and second video streams simultaneously from each of said first and second video sources through said common video access component over said network connection.

47. The system of claim 44, wherein said at least one video source comprises at least a first video source and a second video source; and wherein said viewing client is further configured to:
receive information over said network connection from said first video source regarding video capabilities of said first video source;
receive information over said network connection from said second video source regarding video capabilities of said second video source;
analyze said received information regarding video capabilities of said first and second video sources to determine if said first video source is capable of providing said first video stream and said second video source is capable of providing said second video stream of a high quality region of interest (HQ-ROI) corresponding to said first video stream;
access over said network connection said first video stream from said first video source for delivery over said network connection, and access over said network connection said second video stream from said second video source for delivery over said network connection;
receive said first and second video streams simultaneously from said respective first and second video sources over said network connection; and
simultaneously display said received first and second video streams.

48. The system of claim 47, further comprising:
a first video source configured to be coupled to provide said first video stream over said network connection in response to a request for said first video stream from said viewing client, said first video source being further configured to provide said information over said network connection regarding video capabilities of said first video source; and
a second video source configured to be coupled to provide a second video stream over said network connection in response to a request for said second video stream from said viewing client, and said second video source being further configured to provide said information over said network connection regarding video capabilities of said second video source.

49. The system of claim 45, wherein said viewing client is further configured to at least partially overlay said displayed first video stream with said HQ-ROI of said displayed second video stream.

50. The system of claim 45, wherein said viewing client is further configured to display said first video stream in a first window; and to display said HQ-ROI of said second video stream in a second window; wherein said second window is smaller than said first window; and wherein said second window overlays said first window.

51. The system of claim 45, wherein said viewing client is further configured to first access, receive and display said HQ-ROI of said second video stream as a first spatial subset of said first video stream simultaneously with said first video stream; and then to subsequently access, receive and display said HQ-ROI of said second video stream as a second spatial subset of said first video stream simultaneously with said first video stream; wherein said second spatial subset is a different spatial subset of said first video stream than said first spatial subset.

52. The system of claim 51, wherein said second video source is further configured to communicate said HQ-ROI of said second video stream over said network connection to said viewing client as said second spatial subset of said first video stream in response to a command received by said second video source over said network connection from said viewing client; and wherein said viewing client is further configured to dynamically manipulate said HQ-ROI by first receiving and displaying said HQ-ROI of said second video stream as a first spatial subset of said first video stream simultaneously with said first video stream; and then subsequently receiving and displaying said HQ-ROI of said second video stream as a second spatial subset of said first video stream simultaneously with said first video stream.

53. The system of claim 51, wherein said second video source is further configured to subsequently provide said HQ-ROI of said second video stream as said second spatial subset of said first video stream in response to a pan-tilt-zoom (PTZ) control command received by said second video source over a network connection.

54. The system of claim 51, wherein said second video source is further configured to at least one of: zoom said HQ-ROI of said second video stream by changing the scaling factor of video images within said second video stream before providing said second video stream over said network connection; resize said HQ-ROI of said second video stream by changing the spatial dimensions associated with video images within said second video stream before providing said second video stream over said network connection, or a combination thereof.

55. The method of claim 45, wherein said HQ-ROI of said second video stream has at least one of higher resolution, less video compression, enhanced color format or greater pixel definition than said first video stream.

56. The method of claim 55, wherein said HQ-ROI of said second video stream has a higher resolution than said first video stream.

57. The system of claim 44, wherein said at least one video source is coupled to a video access component; and wherein said viewing client is further configured to receive said first and second video streams simultaneously from said at least one video source through said video access component over said network connection.
